(19) United States
(12) Patent Application Publication
(10) Pub. No.: US 2025/0149834 A1
(43) Pub. Date: May 8, 2025

(54) ELECTRICAL CONNECTOR HAVING LEADFRAME ASSEMBLIES SEPARATED BY AIR GAPS

(71) Applicant: SAMTEC, INC., New Albany, IN (US)

(72) Inventors: Randall Eugene MUSSER, New Albany, IN (US); Jonathan E. BUCK, New Albany, IN (US); Madhumitha RENGARAJAN, Mechanicsburg, PA (US)

(21) Appl. No.: 18/833,466

(22) PCT Filed: Jan. 27, 2023
(86) PCT No.: PCT/US2023/061418

§ 371 Date: Jul. 26, 2024

Related U.S. Application Data
(60) Provisional application No. 63/304,488, filed on Jan. 28, 2022.

(51) Int. Cl. H01R 13/6587; H01R 12/72; H01R 13/6477

(52) U.S. Cl. CPC H01R 13/6587; H01R 12/724; H01R 13/6477

(57) ABSTRACT

An electrical connector includes a connector housing that supports a plurality of leadframe assemblies that include a ground plate and a signal wafer that abuts the ground plate. The signal wafer of one leadframe assembly is spaced from the ground plate of an adjacent signal wafer so as to define an air gap therebetween. A housing portion defines at least one, at least two, at least three or three or more discrete, adjustable skew correction areas, skew voids or respective air voids.

### CROSS-REFERENCE TO RELATED APPLICATIONS

This claims priority to U.S. Patent Application Ser. No. 63/304,488 filed Jan. 28, 2022, the disclosure of which is hereby incorporated by reference as if set forth in its entirety herein.

### BACKGROUND

Electrical connectors include electrical contacts that mount to respective electrical components, and mate with each other to communicate signals between the electrical components. The electrical contacts typically include electrical signal contacts that carry the signals, and grounds that shield the various signal contacts from each other. In some connector designs, the grounds are defined by ground shields that are typically disposed between signal contacts or pairs of signal contacts. Operation of electrical connectors are known to produce undesirable interference, or “cross talk.” Cross talk occurs when one signal contact induces electrical interference in an adjacent signal contact due to intermingling electrical fields, thereby compromising signal integrity. While ground shields are known to reduce cross-talk, cross-talk can still reach undesirable levels particularly when operating the electrical connectors are high data transfer speeds.

With electronic device miniaturization and high speed, high signal integrity electronic communications becoming more prevalent, the reduction of cross talk remains a significant factor in connector design.

### SUMMARY

In accordance with one aspect of the present disclosure, an electrical connector, such as a micro backplane connector, can include an electrically insulative connector housing, and a pair of first and second adjacent leadframe assemblies supported by the connector housing. Each leadframe assembly can include an electrically insulative leadframe housing, a plurality of signal contacts supported by the leadframe housing, and a ground plate secured to the leadframe housing. At least respective portions of the leadframe assemblies of the pair of leadframe assemblies are separated from each other along a lateral direction by an air gap.

### BRIEF DESCRIPTION OF THE DRAWINGS

FIG. 1 is a front perspective view of an electrical connector including a connector housing and a plurality of leadframe assemblies supported by the connector housing;

FIG. 2 is a front elevation view of the electrical connector of FIG. 1;

FIG. 3A is a perspective view of one of the leadframe assemblies of FIG. 1;

FIG. 3B is another perspective view of the leadframe assembly of FIG. 3A;

FIG. 3C is an exploded perspective view of the leadframe assembly of FIG. 3A;

FIG. 4 is a rear perspective view of the electrical connector of FIG. 1, shown aligned to be mounted to an underlying substrate;

FIG. 5A is a front perspective view of the connector housing of the electrical connector of FIG. 1;

FIG. 5B is a sectional side elevation view of the electrical connector of FIG. 1;

FIG. 6 is a perspective view of the electrical connector of FIG. 1, shown with the connector housing removed;

FIG. 7 is a sectional perspective view of the electrical connector of FIG. 1;

FIG. 8 is a rear elevation view of the electrical connector of FIG. 1, but including dimensional information;

FIG. 9 is a perspective view of an electrical connector assembly showing the electrical connector of FIG. 1 supported in an electrically conductive cage;

FIG. 10 is a perspective view of an electrical connector assembly showing the electrical connector of FIG. 1 mounted to a bundle of electrical cables;

FIG. 11 is a perspective view of an electrical connector assembly showing the electrical connector of FIG. 1 but including a greater number of electrical contacts, showing the electrical connector secured to a panel and mounted to a plurality of cables;

FIG. 12 is a perspective view of an electrical connector constructed in accordance with another example;

FIG. 13 is another perspective view of the electrical connector of FIG. 12;

FIG. 14 is another perspective view of the electrical connector of FIG. 12;

FIG. 15 is another perspective view of the electrical connector of FIG. 12;

FIG. 16 is another perspective view of the electrical connector of FIG. 12;

FIG. 17 is another perspective view of the electrical connector of FIG. 12;

FIG. 18 is another perspective view of the electrical connector of FIG. 12;

FIG. 19 is another perspective view of the electrical connector of FIG. 12;

FIG. 20 is a front elevation view of the electrical connector of FIG. 12;

FIG. 21 is a rear elevation view of the electrical connector of FIG. 12;

FIG. 22 is a top plan view of the electrical connector of FIG. 12;

FIG. 23 is a bottom plan view of the electrical connector of FIG. 12;

FIG. 24 is an end elevation view of the electrical connector of FIG. 12;

FIG. 25 is another end elevation view of the electrical connector of FIG. 12;

FIG. 26 is a perspective view of an electrical connector constructed in accordance with another example;

FIG. 27 is another perspective view of the electrical connector of FIG. 26;

FIG. 28 is another perspective view of the electrical connector of FIG. 26;

FIG. 29 is another perspective view of the electrical connector of FIG. 26;

FIG. 30 is another perspective view of the electrical connector of FIG. 26;

FIG. 31 is another perspective view of the electrical connector of FIG. 26;

FIG. 32 is another perspective view of the electrical connector of FIG. 26;

FIG. 33 is another perspective view of the electrical connector of FIG. 26;

FIG. 34 is a front elevation view of the electrical connector of FIG. 26;

FIG. 35 is a rear elevation view of the electrical connector of FIG. 26;

FIG. 36 is a top elevation view of the electrical connector of FIG. 26;

FIG. 37 is a bottom view of the electrical connector of FIG. 26;

FIG. 38 is an end elevation view of the electrical connector of FIG. 26;

FIG. 39 is another end elevation view of the electrical connector of FIG. 26;

FIG. 40 is a perspective view of an electrical connector constructed in accordance with another example;

FIG. 41 is another perspective view of the electrical connector of FIG. 40;

FIG. 42 is another perspective view of the electrical connector of FIG. 40;

FIG. 43 is another perspective view of the electrical connector of FIG. 40;

FIG. 44 is another perspective view of the electrical connector of FIG. 40;

FIG. 45 is another perspective view of the electrical connector of FIG. 40;

FIG. 46 is another perspective view of the electrical connector of FIG. 40;

FIG. 47 is another perspective view of the electrical connector of FIG. 40;

FIG. 48 is another perspective view of the electrical connector of FIG. 40;

FIG. 49 is another perspective view of the electrical connector of FIG. 40;

FIG. 50 is a front elevation view of the electrical connector of FIG. 40;

FIG. 51 is a rear elevation view of the electrical connector of FIG. 40;

FIG. 52 is a top plan view of the electrical connector of FIG. 40;

FIG. 53 is a bottom plan view of the electrical connector of FIG. 40;

FIG. 54 is an end elevation view of the electrical connector of FIG. 40;

FIG. 55 is another end elevation view of the electrical connector of FIG. 40;

FIG. 56 is a perspective view of an electrical connector constructed in accordance with another example;

FIG. 57 is another perspective view of the electrical connector of FIG. 56;

FIG. 58 is another perspective view of the electrical connector of FIG. 56;

FIG. 59 is another perspective view of the electrical connector of FIG. 56;

FIG. 60 is another perspective view of the electrical connector of FIG. 56;

FIG. 61 is another perspective view of the electrical connector of FIG. 56;

FIG. 62 is another perspective view of the electrical connector of FIG. 56;

FIG. 63 is another perspective view of the electrical connector of FIG. 56;

FIG. 64 is another perspective view of the electrical connector of FIG. 56;

FIG. 65 is another perspective view of the electrical connector of FIG. 56;

FIG. 66 is a front elevation view of the electrical connector of FIG. 56;

FIG. 67 is a rear elevation view of the electrical connector of FIG. 56;

FIG. 68 is a top plan view of the electrical connector of FIG. 56;

FIG. 69 is a bottom plan view of the electrical connector of FIG. 56;

FIG. 70 is an end elevation view of the electrical connector of FIG. 56; and

FIG. 71 is another end elevation view of the electrical connector of FIG. 56.

### DETAILED DESCRIPTION

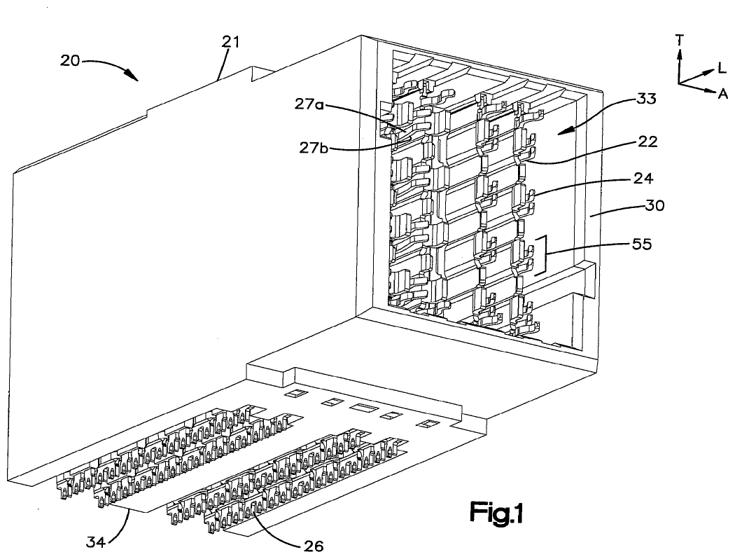

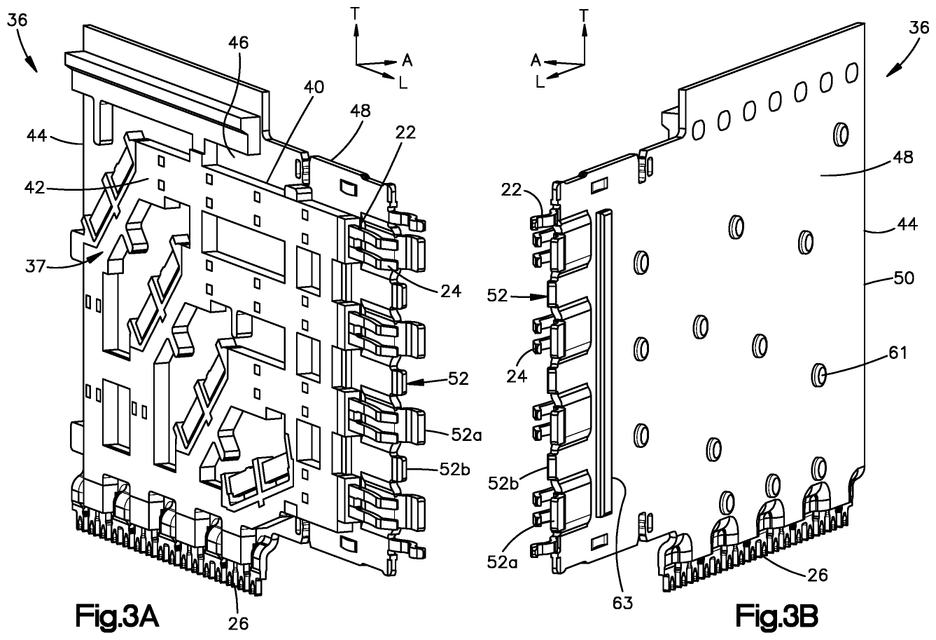

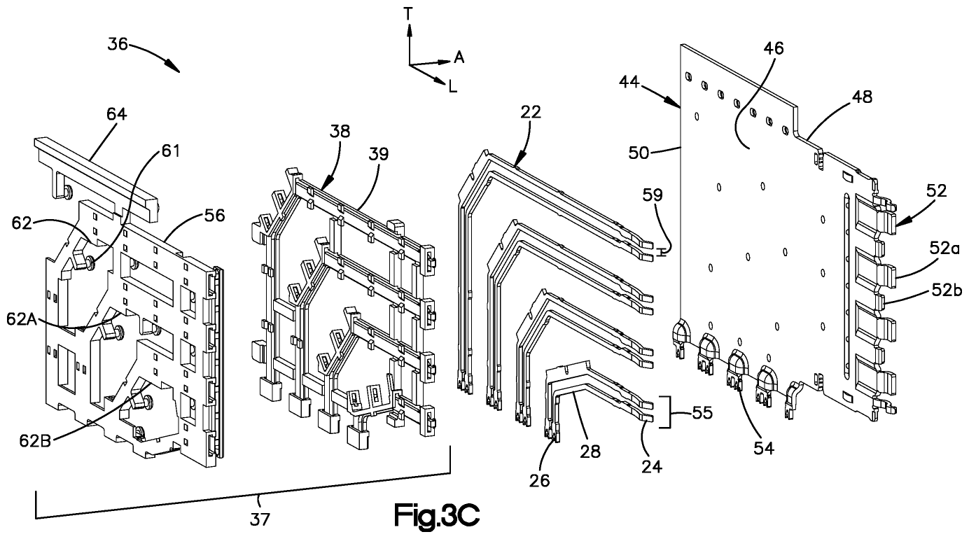

Referring to FIG. 1, an electrical connector 20 includes a dielectric or electrically insulative connector housing 21 and a plurality of electrical contacts 22 that are supported by the connector housing 21. The electrically insulative connector housing 21 can be made from any suitable electrically nonconductive polymer as desired. For instance, the electrically insulative connector housing 21 can be a plastic. The electrical contacts 22 can be made of a metal such as copper, silver, gold, or any alternative suitably electrically conductive material as desired. The electrical contacts 22 define mating portions 24 and mounting portions 26 opposite the mating portions 24. The electrical contacts 22 can define intermediate regions 28 (see FIG. 3C) disposed between the mating portions 24 and the mounting portions 26. In one example, the electrical connector 20 can be configured as a right-angle electrical connector whereby the mating portions 24 are oriented perpendicular to the mounting portion 26. For instance, the mating portions 24 can be oriented substantially along the longitudinal direction L, and the mounting portions 26 can be oriented substantially along a transverse direction T that is perpendicular to the longitudinal direction L. Thus, the intermediate portions 28 can be angled, bent, curved, or otherwise shaped and configured such that the mating portion 24 and the mounting portion 26 are oriented along their respective directions.

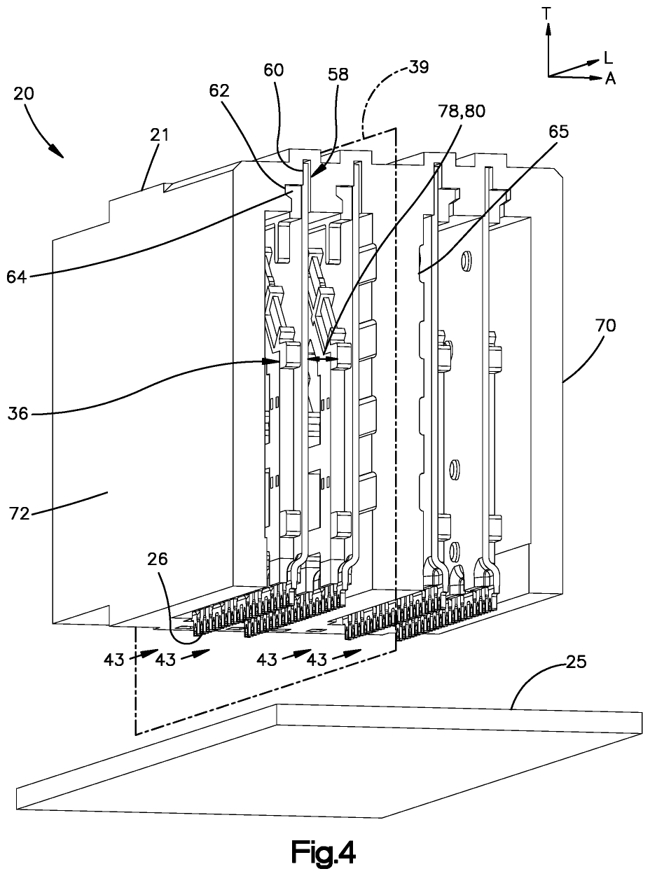

The mating portions 24 are configured to mate with respective mating portions of complementary electrical contacts of a complementary electrical component, such as a complementary electrical connector so as to mate the electrical connector 20 with the complementary electrical connector along a forward or mating direction. In one example, the complementary electrical connector can be constructed as described in International Patent Application Serial No. PCT/US2020/052372 filed Sep. 24, 2020, the disclosure of which is hereby incorporated by reference as if set forth in its entirety herein. The mating direction can be oriented along the longitudinal direction L. The electrical connector 20 can be unmated from the complementary electrical connector along a rearward or unmating direction that is opposite the mating direction and also oriented along the longitudinal direction L. The mounting portions 26 are configured to be mounted to a complementary electrical component such as a substrate 25 (see FIG. 4) that can be configured as a PCB. Thus, when the electrical connector 20 is mated with the complementary electrical device and the complementary electrical component, the electrical connector 20 can transmit signals between the complementary electrical device and the complementary electrical component.

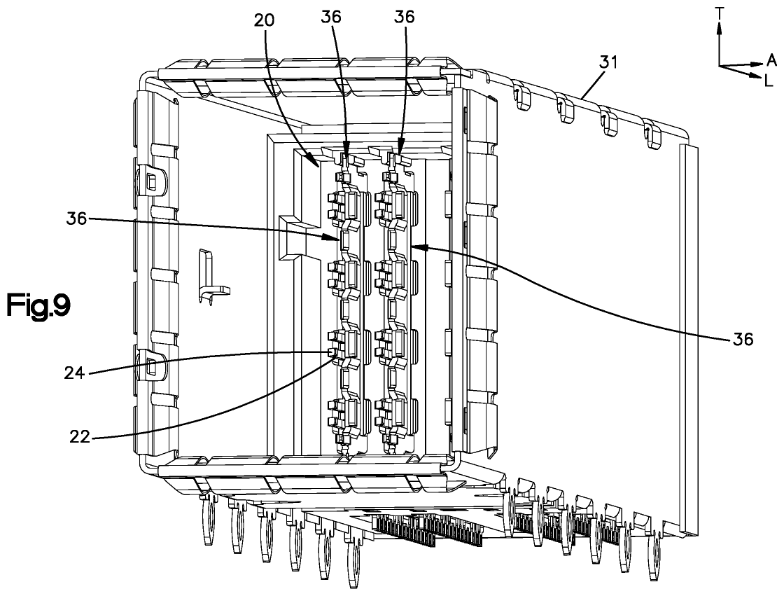

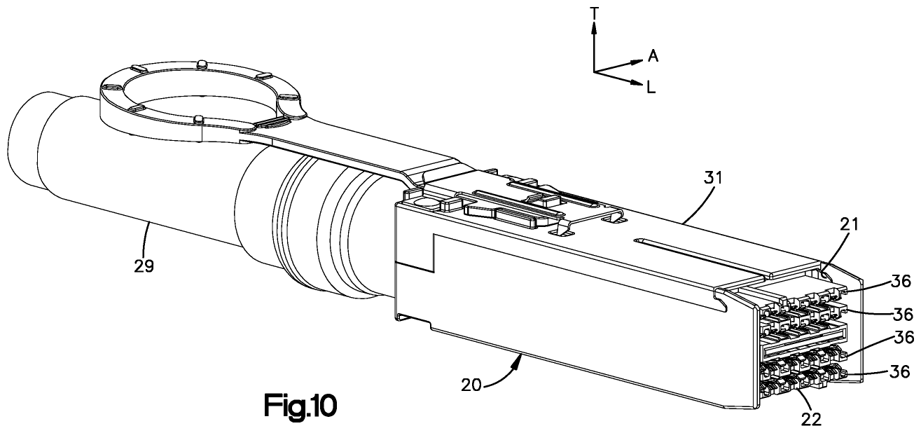

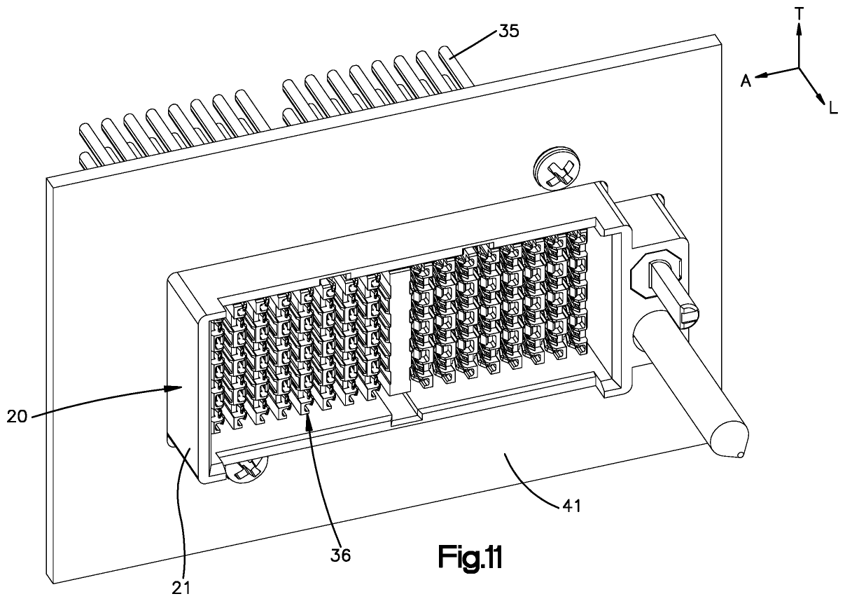

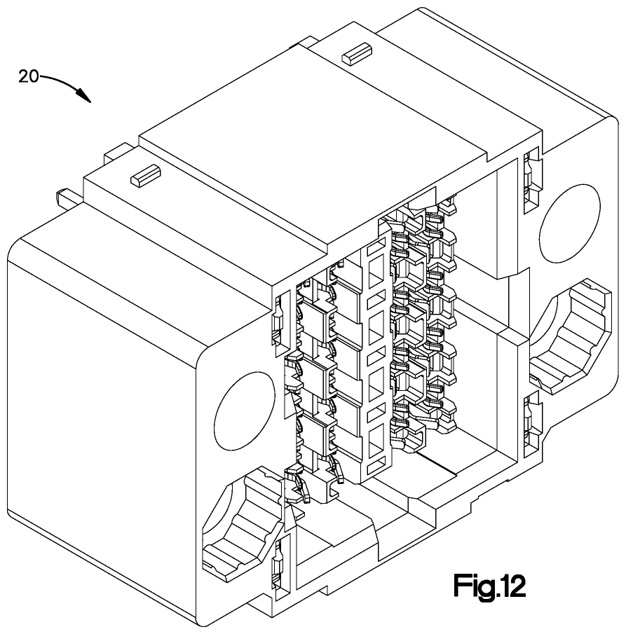

As illustrated at FIGS. 9-10, the complementary electrical connector can be mounted to a respective plurality of electrical cables 35 (see FIG. 11) in one example. The electrical cables can be bundled in an outer jacket 29. Further, the electrical connector 20 and the complementary electrical connector can mate with each other inside an outer electrical shield 31 that surrounds the electrical connectors. The outer electrical shield 31 can be made from metal in one example. Accordingly, when the electrical connector 20 and the complementary electrical connector are mated to each other, the electrical connector 20 and thus the underlying substrate 25 can be placed in electrical communication with the electrical cables. The electrical cables can, in turn, be placed in electrical communication with an optical transceiver. A first group of electrical cables can transmit electrical signals to the optical transceiver that converts the electrical signals into optical signals, and a second group of electrical cables can receive electrical signals from the optical transceiver that has converted optical signals into the electrical signals that are transmitted along the second group of electrical cables. In other examples, such as shown at FIG. 11, the electrical connector can be an electrical cable connector, whereby the complementary electrical component is defined by a plurality of electrical cables. The electrical connector 20 can be a panel-mounted connector that is mounted onto a panel 41. For instance, the electrical connector 20 can extend through the panel 41, such that the electrical connector 20 is configured to mate with the complementary electrical connector on a first side of the panel 41, and the electrical cables are disposed on a second side of the panel opposite the first side. It should be appreciated that an electrical connector system can include any one or more up to all of the outer electrical shield 31, the panel 41, the complementary electrical connector, the electrical cables 35, and the underlying substrate 25 (see FIG. 4).

Referring again to FIG. 1, the connector housing 21 defines a mating interface 30 that can be defined by a front end of the connector housing 21. The front end can lie in a plane that is defined by the transverse direction T and a lateral direction A that is oriented perpendicular to the transverse direction T and the longitudinal direction L. The mating interface 30 can be defined by a receptacle 33 that extends into the front end of the connector housing. The receptacle can be configured to receive a mating portion of the complementary electrical connector so as to mate the mating portions 24 of the electrical contacts 22 with the complementary electrical contacts. Each mating portion 24 can include a bowed beam having a first side 27a that makes contact with a complementary electrical contact of the complementary electrical connector, and a second side 27b opposite the first side. The first side 27a can be concave, and the second side 27b can be convex. The first and second sides 27a and 27b of the mating portions 24 can extend substantially parallel to each other.

The connector housing 21 further defines mounting interface 34 that is defined by a bottom surface of the connector housing 20 that can face the underlying substrate 25. The mounting portions 26 can extend in a downward direction from the bottom surface of the connector housing 21. The downward direction can be oriented along the transverse direction T. The bottom surface can lie in a plane that is defined by the longitudinal direction L and the lateral direction A. Thus, the mating interface 30 can be oriented orthogonal to the mounting interface 34. The electrical connector 20 can therefore be referred to as a right-angle connector. Alternatively, the electrical connector 20 can be configured as a vertical connector whereby the mating portions 24 and the mounting portions 26 are parallel such as inline with each other, and the mating interface 30 and the mounting interface 34 are parallel with each other.

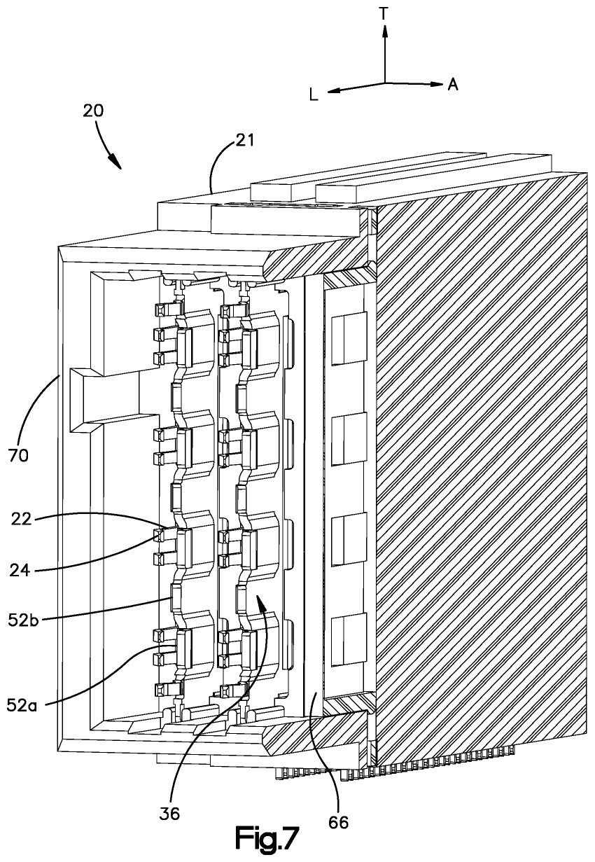

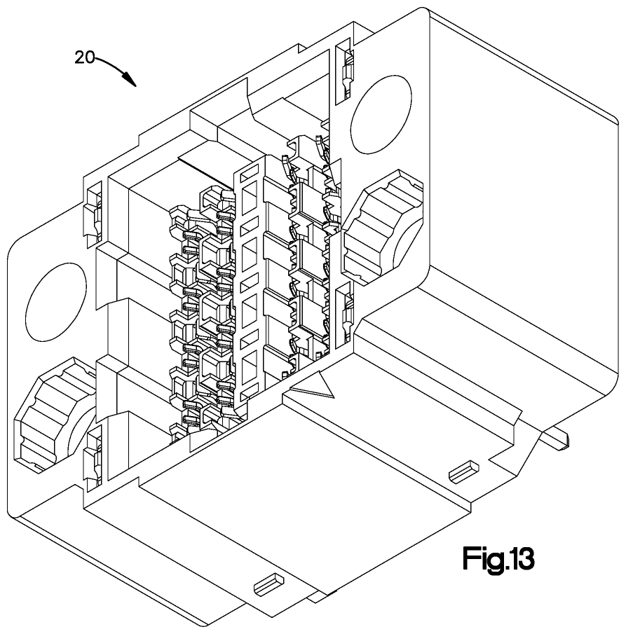

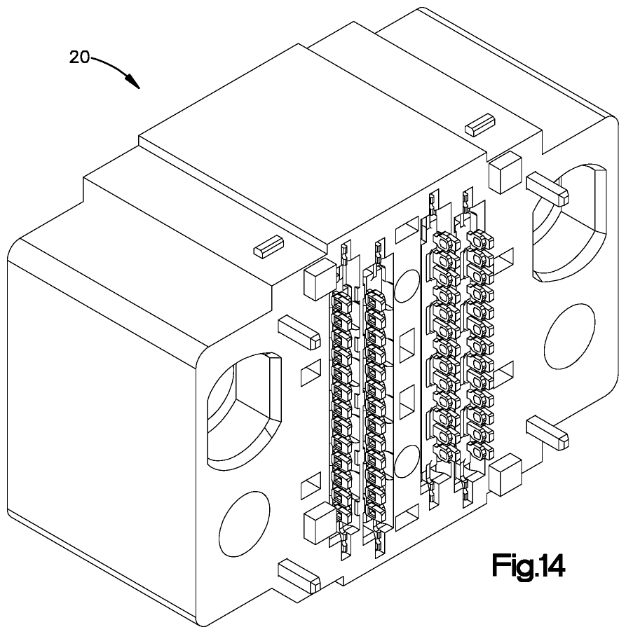

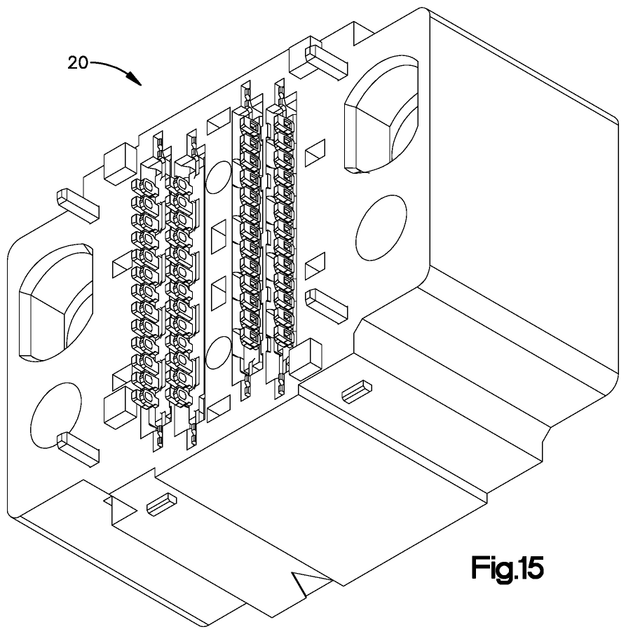

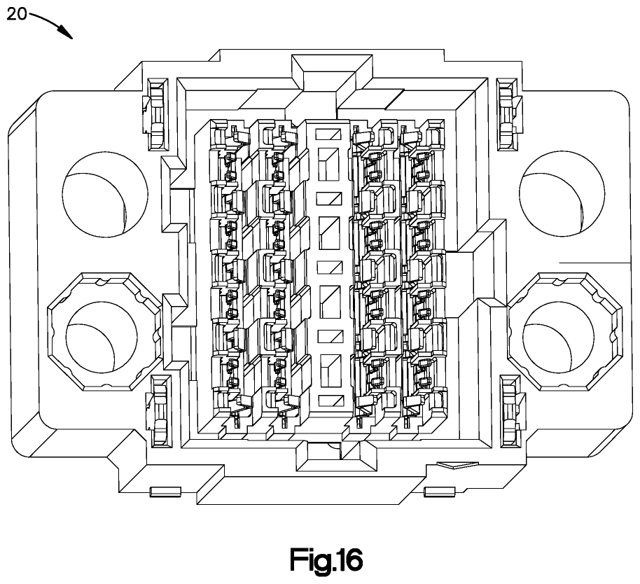

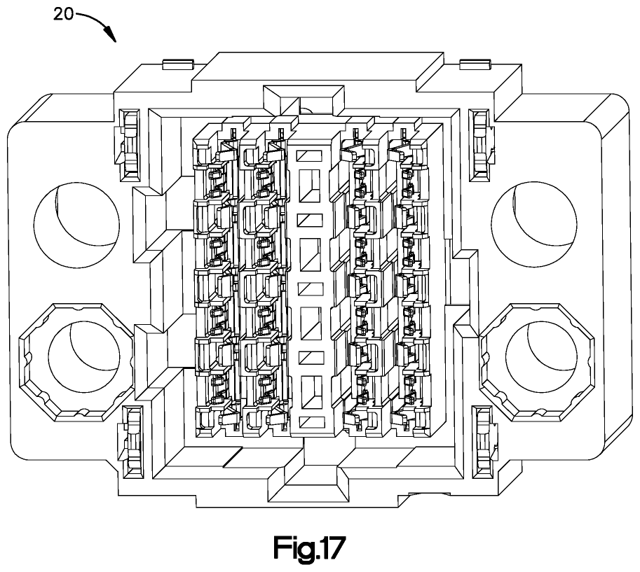

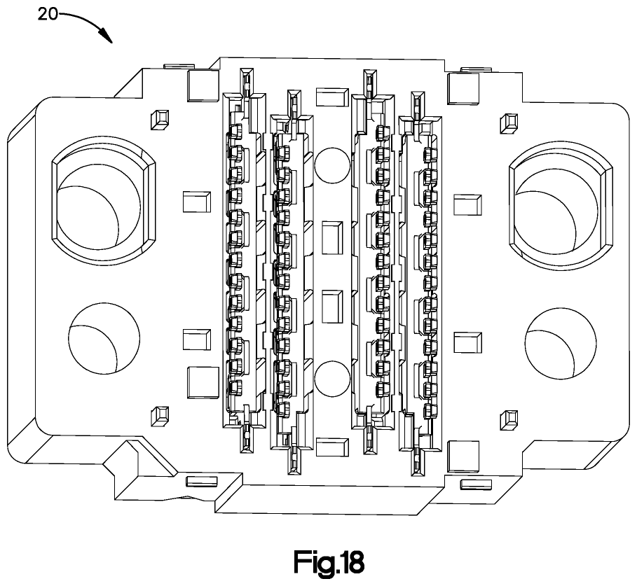

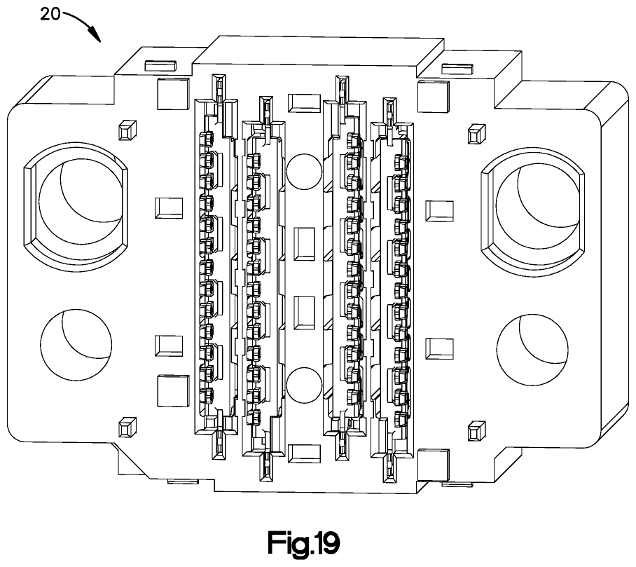

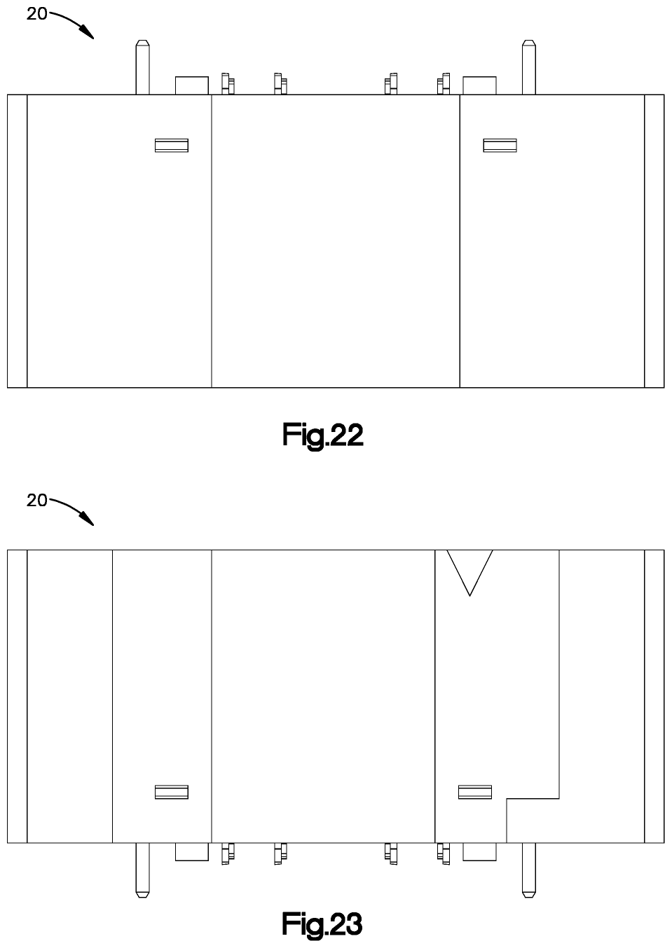

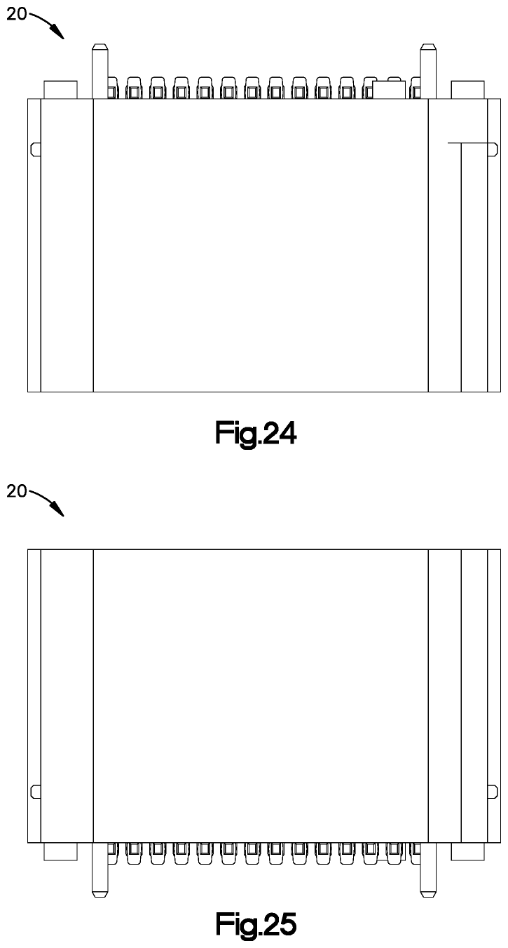

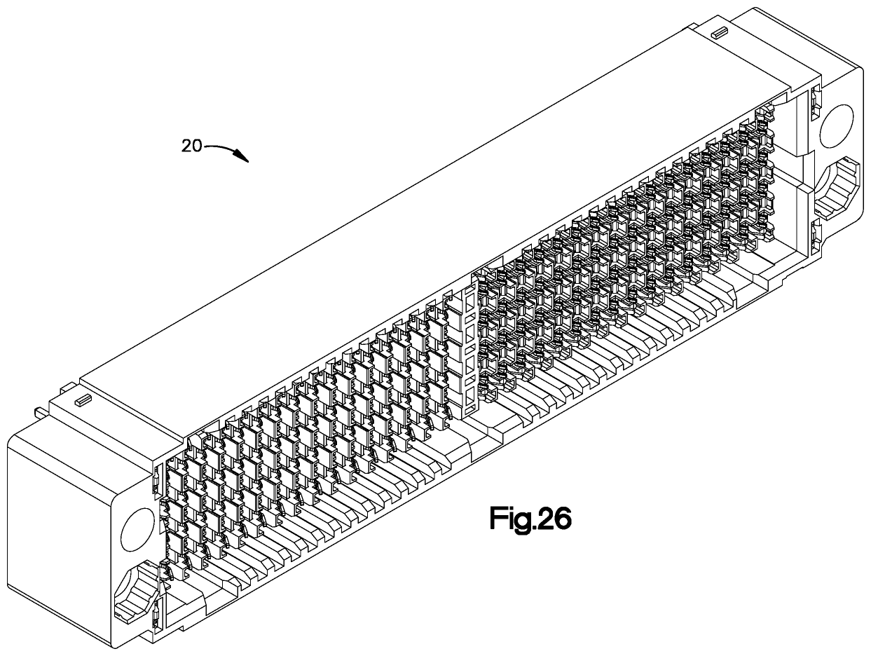

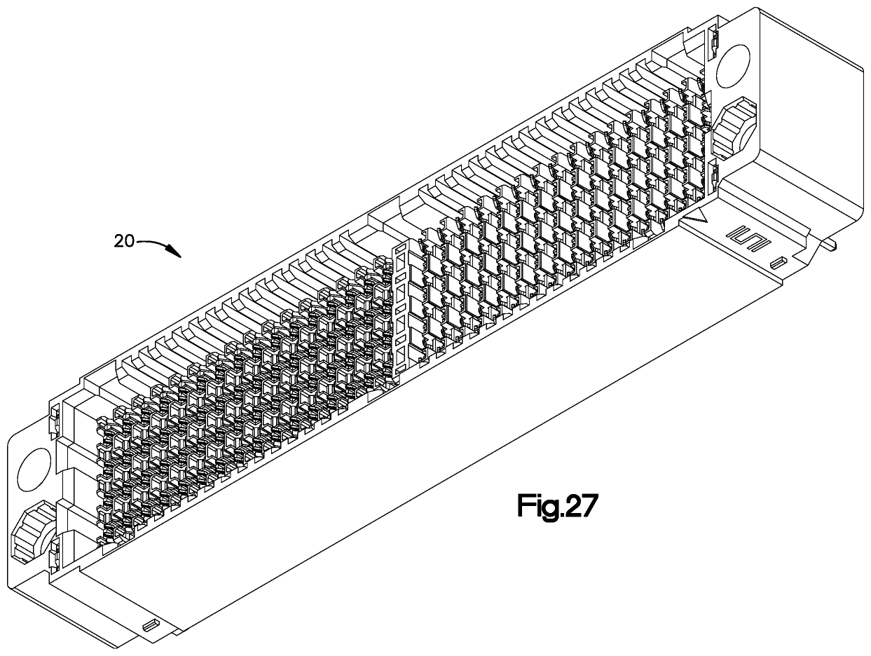

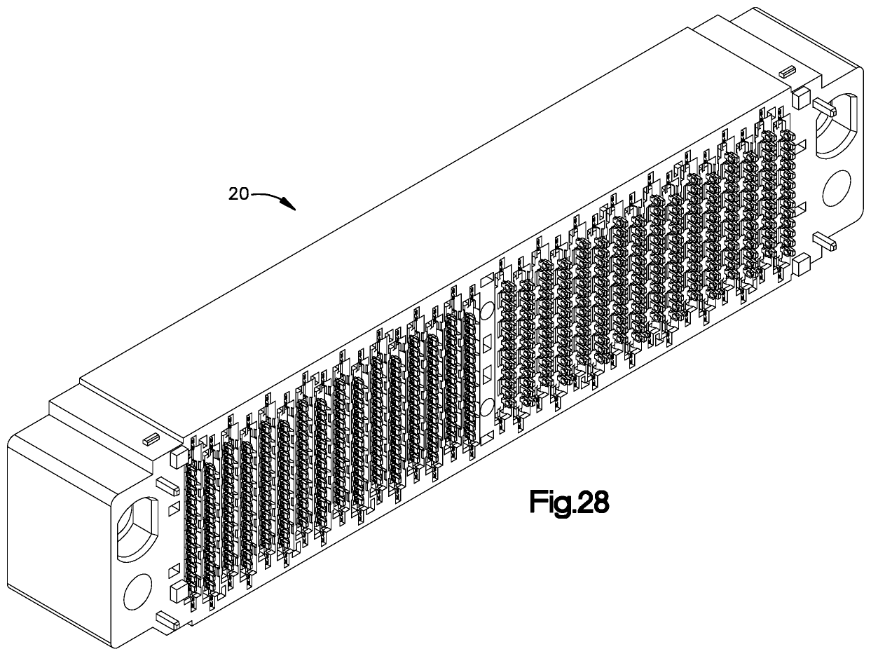

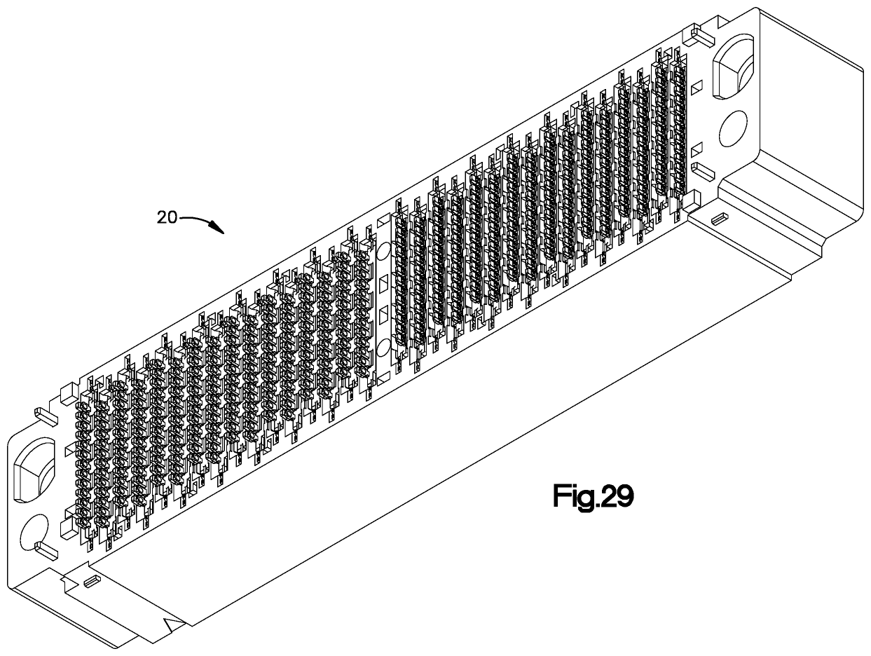

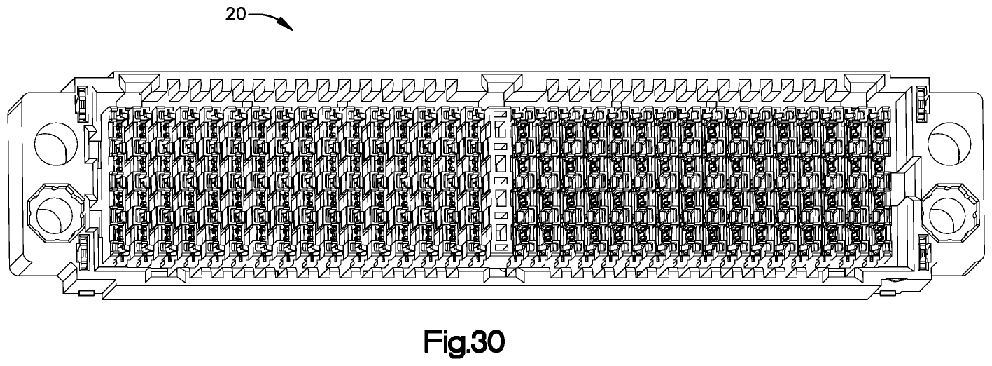

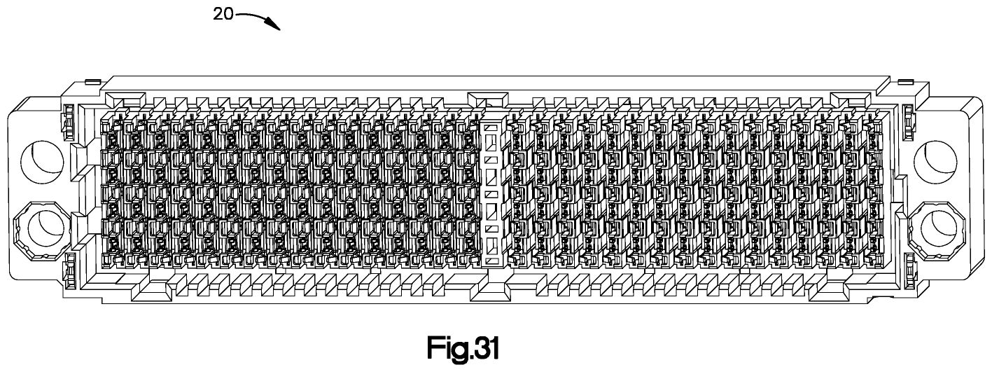

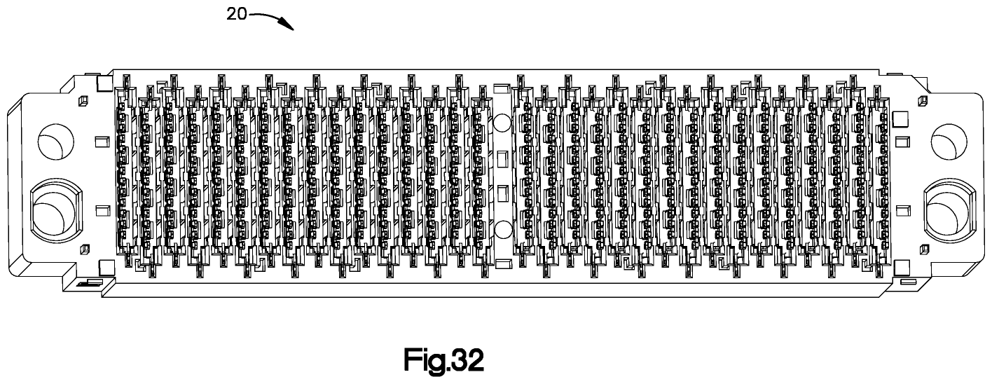

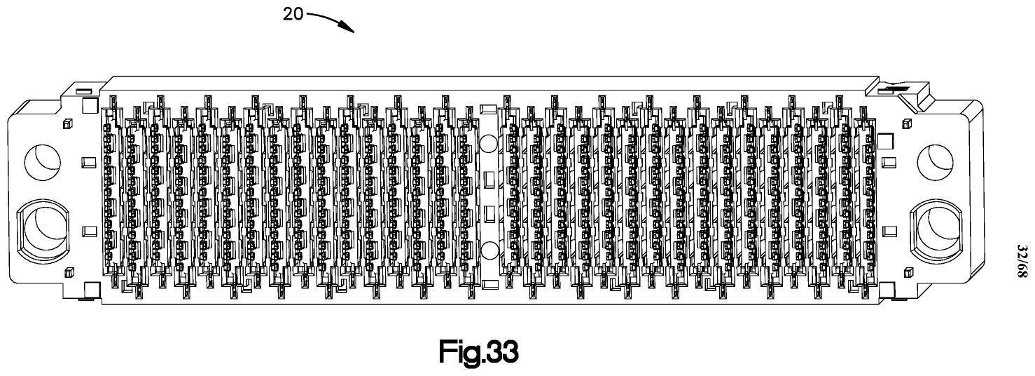

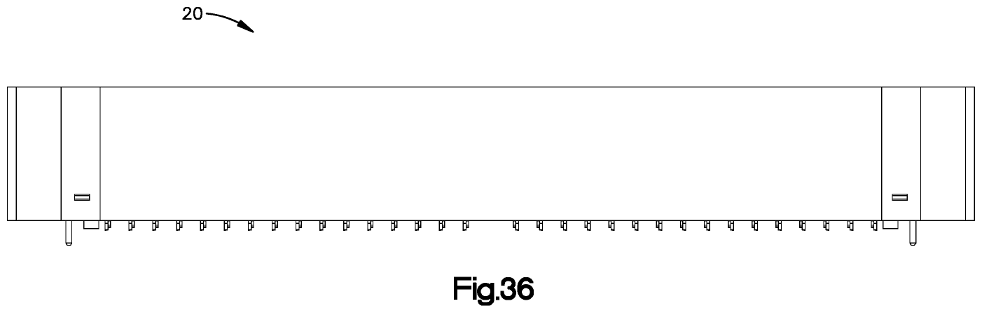

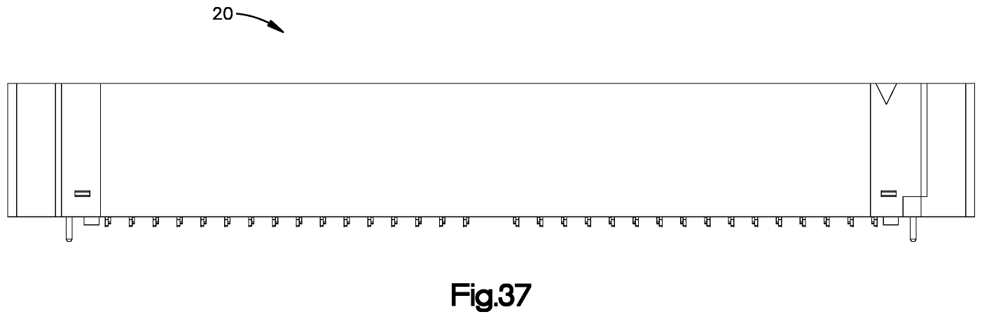

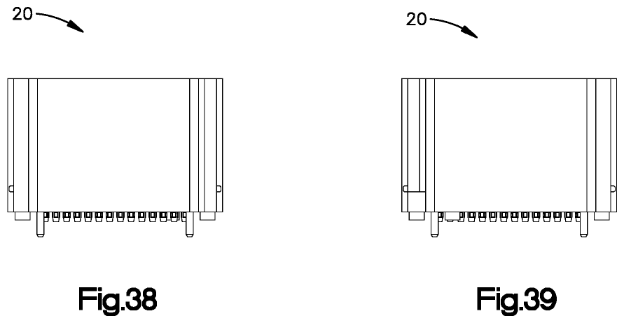

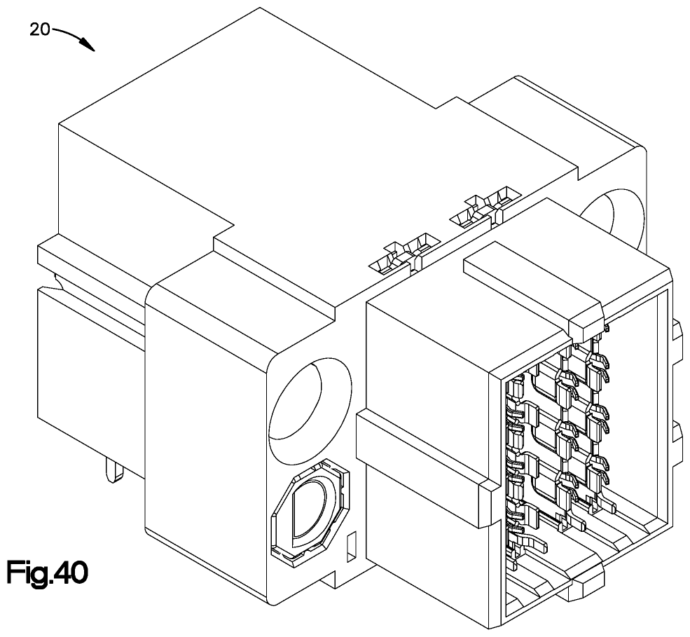

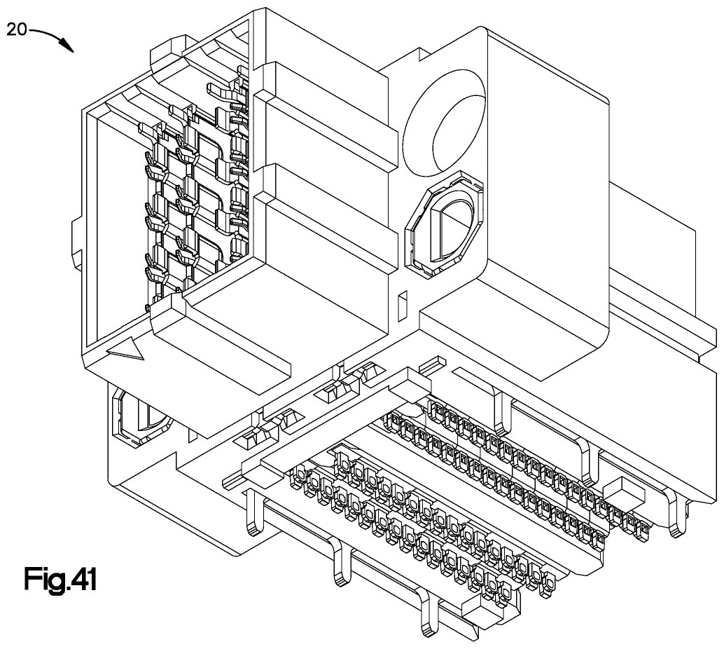

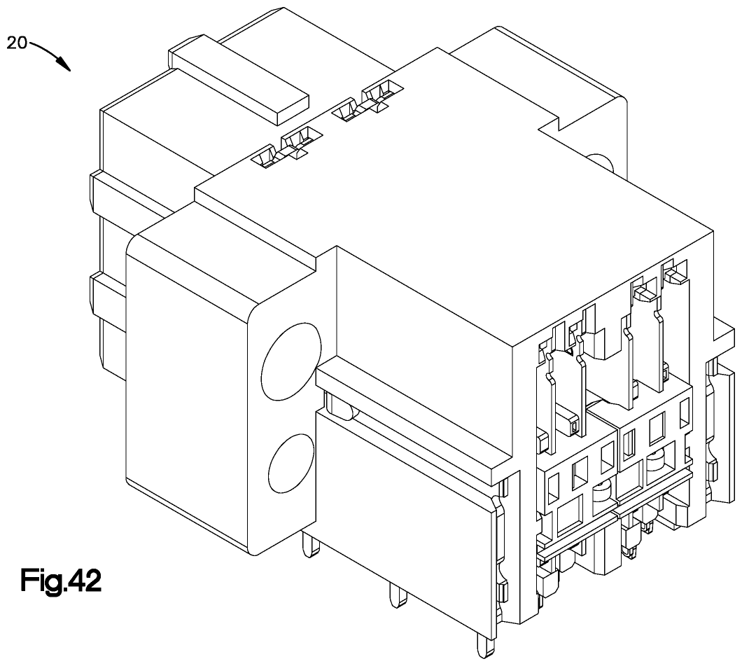

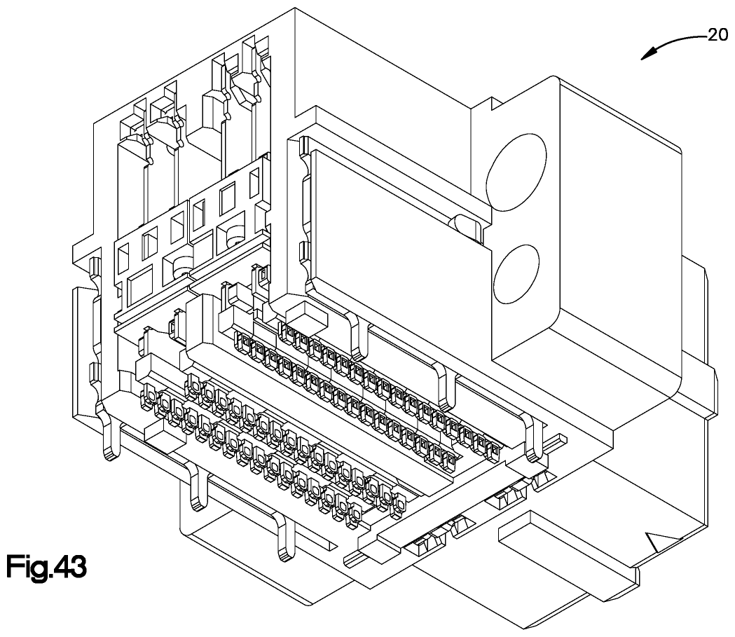

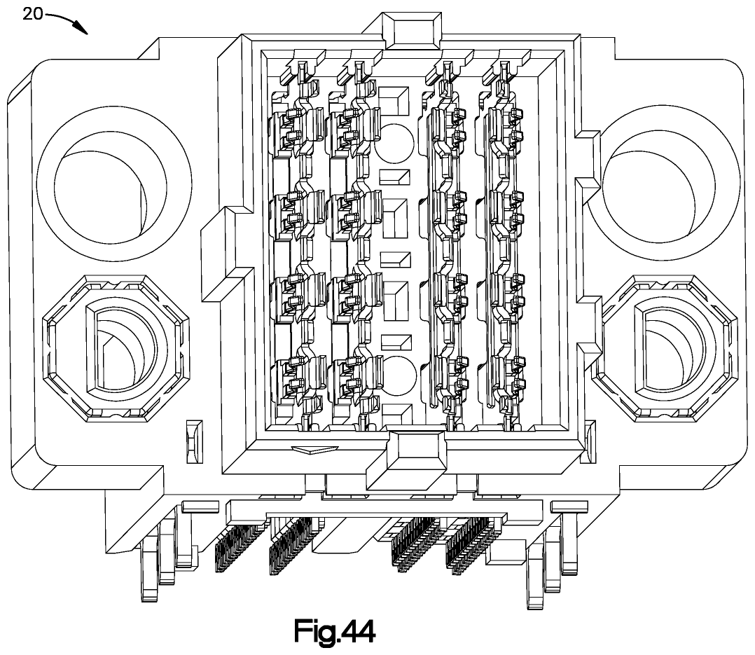

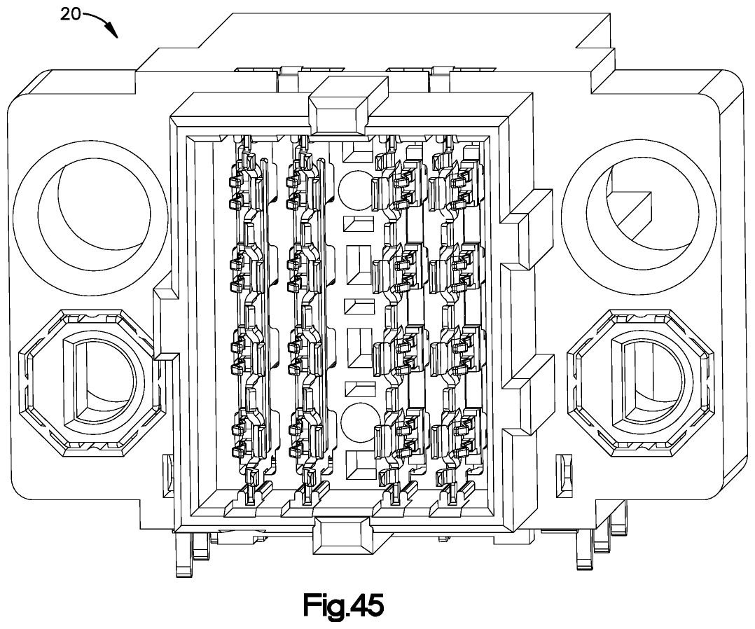

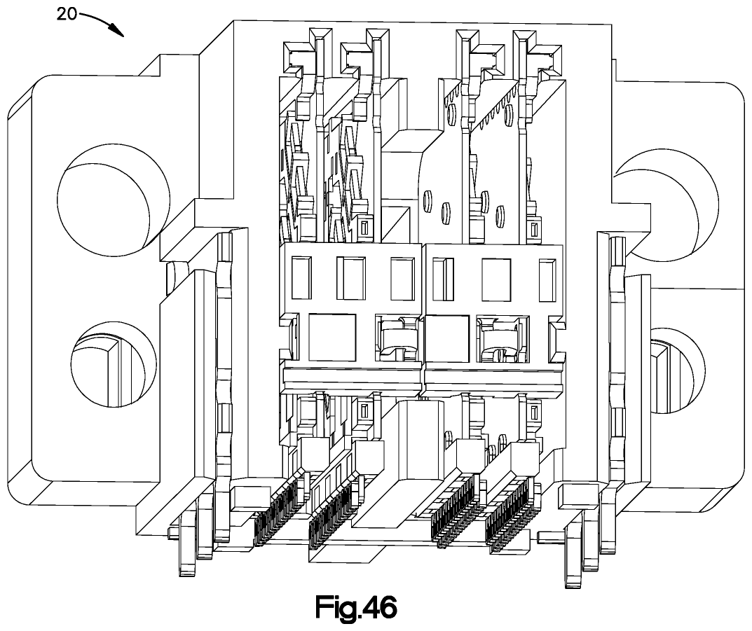

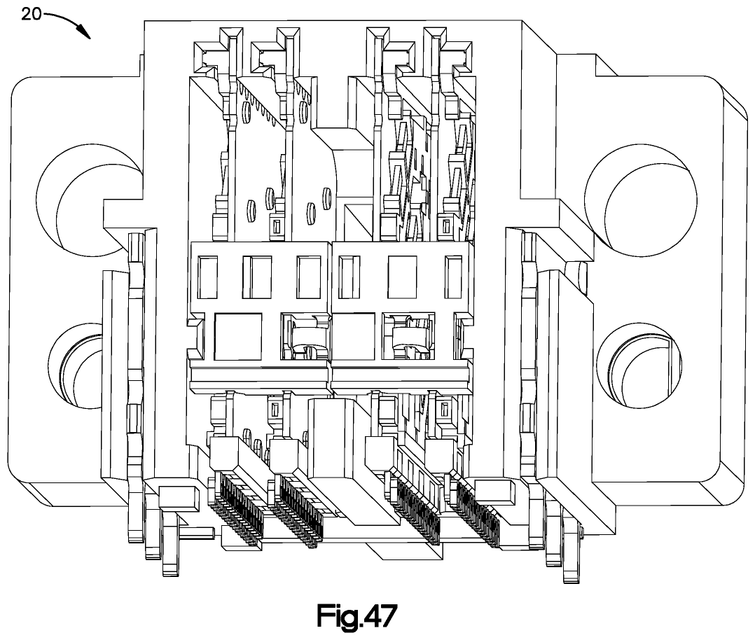

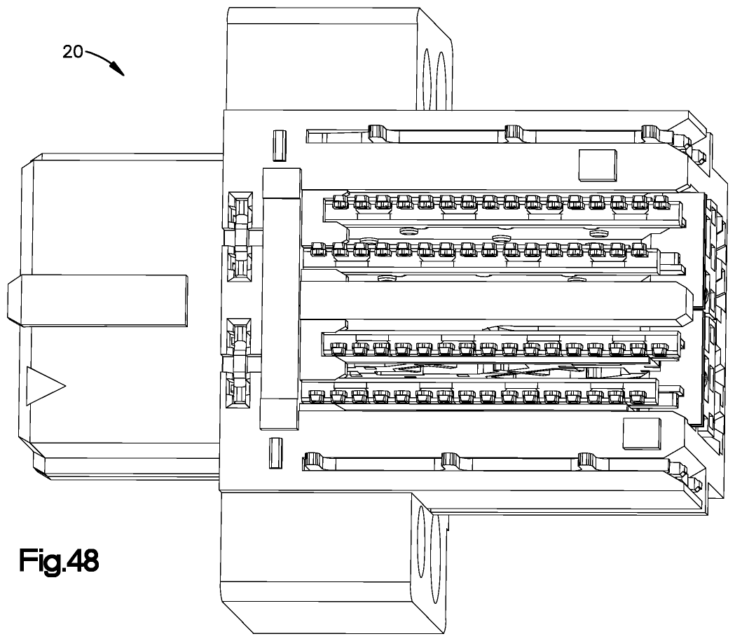

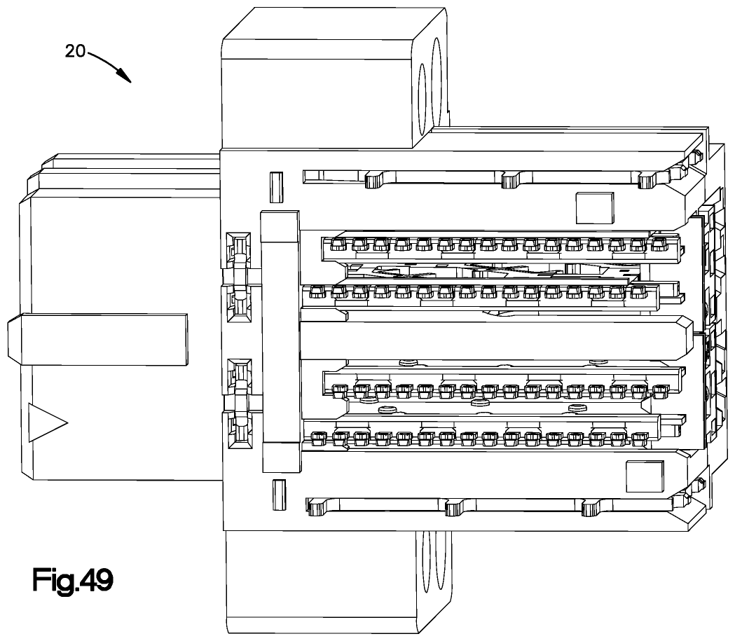

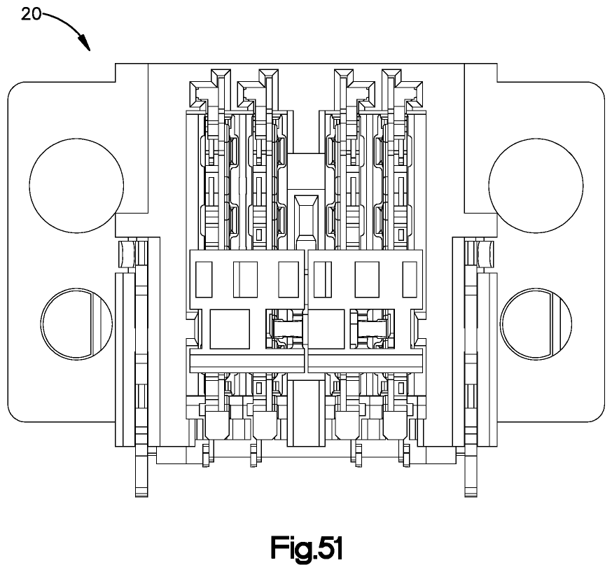

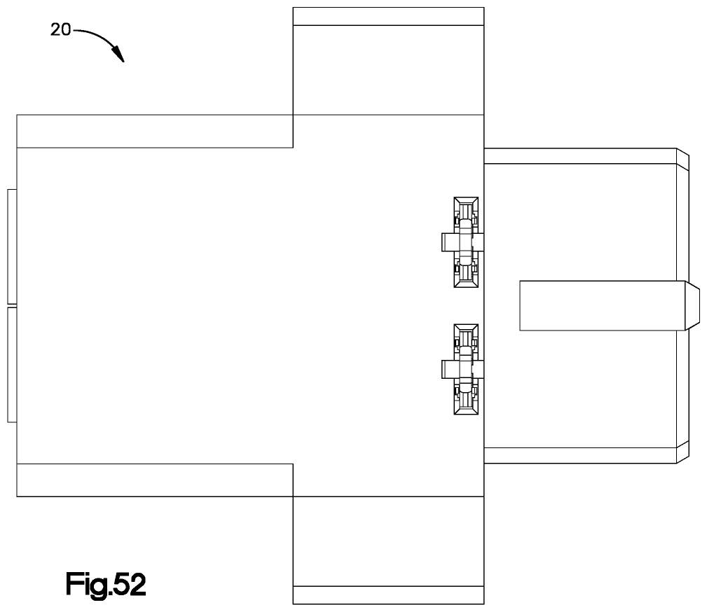

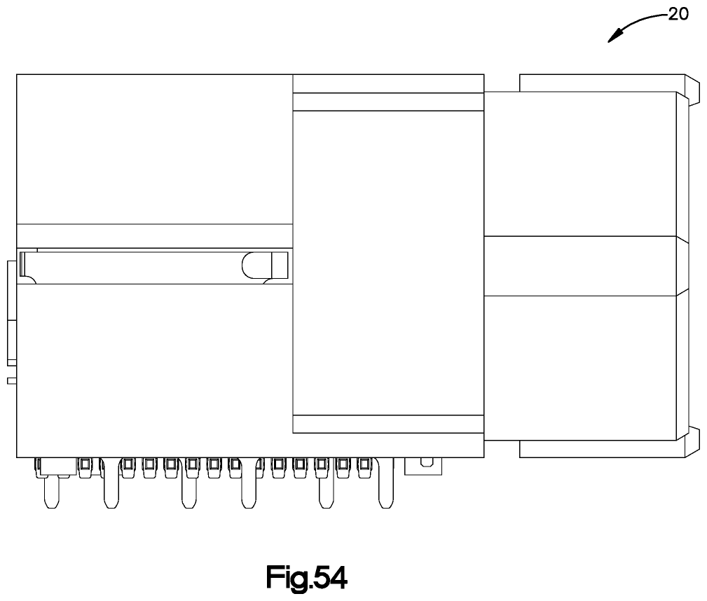

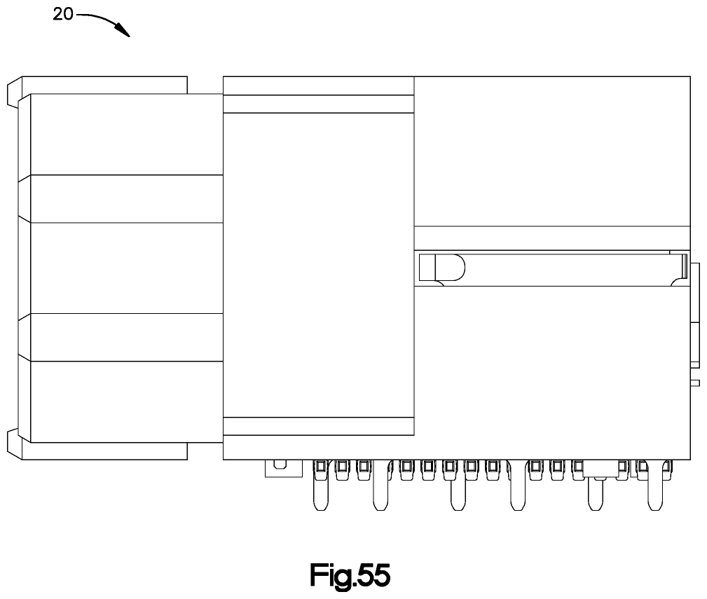

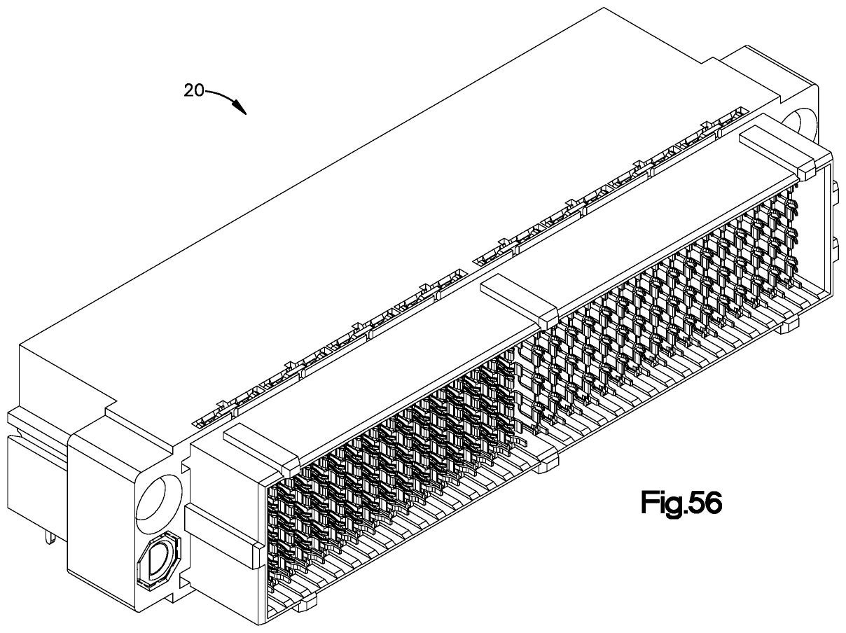

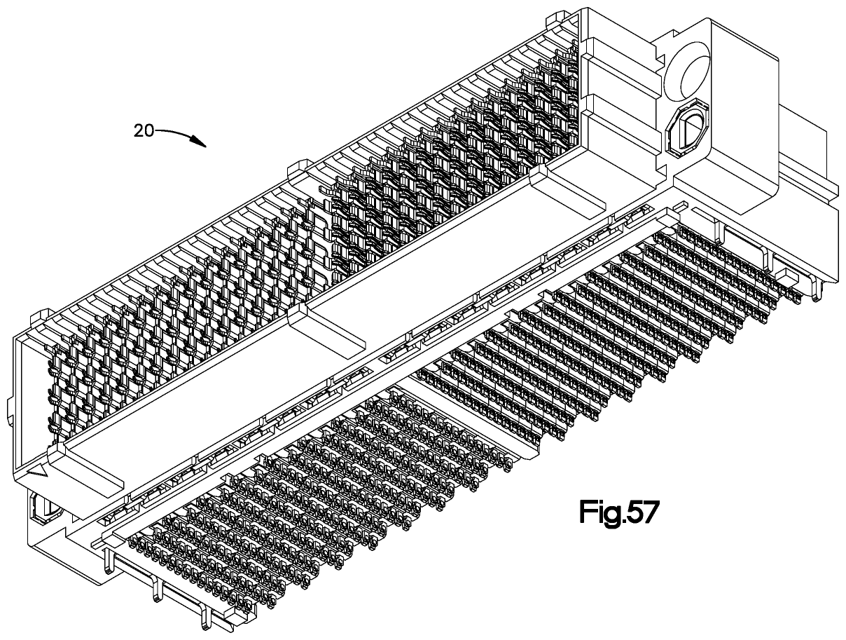

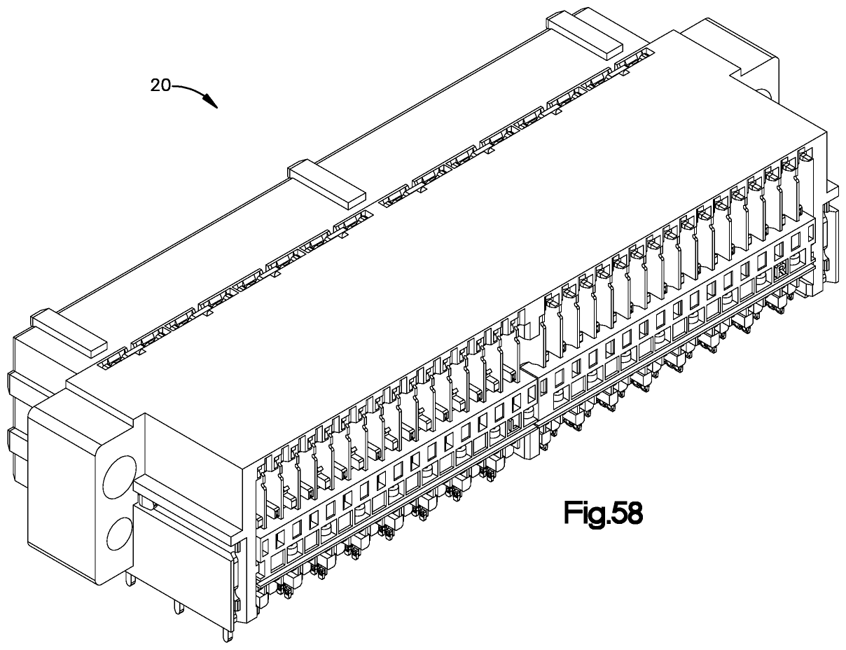

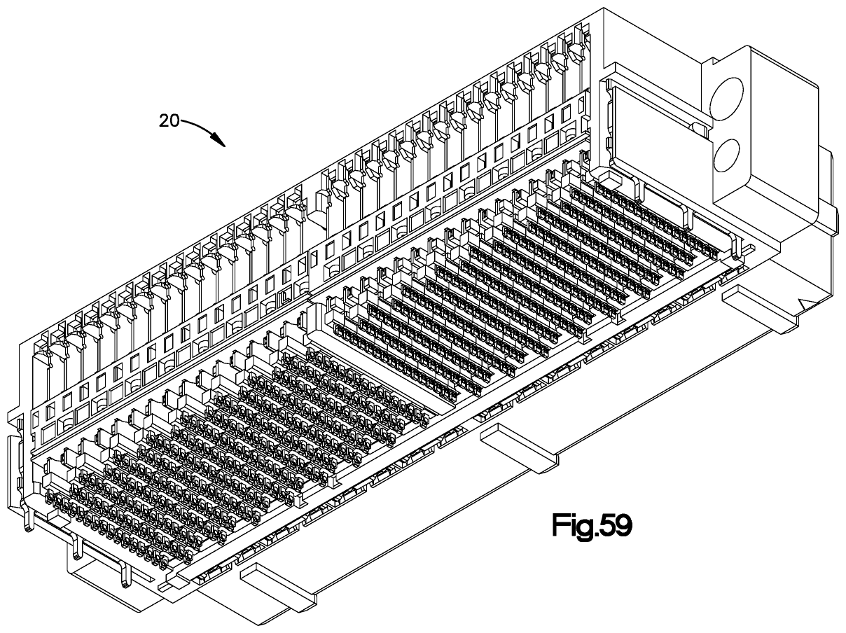

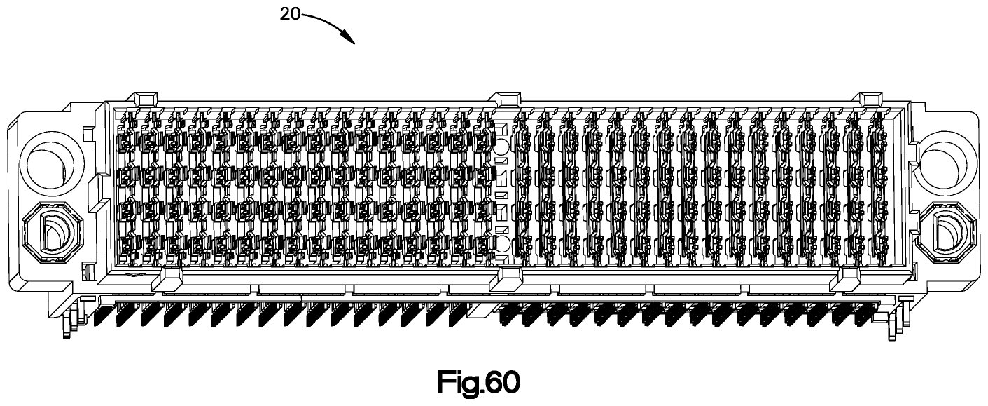

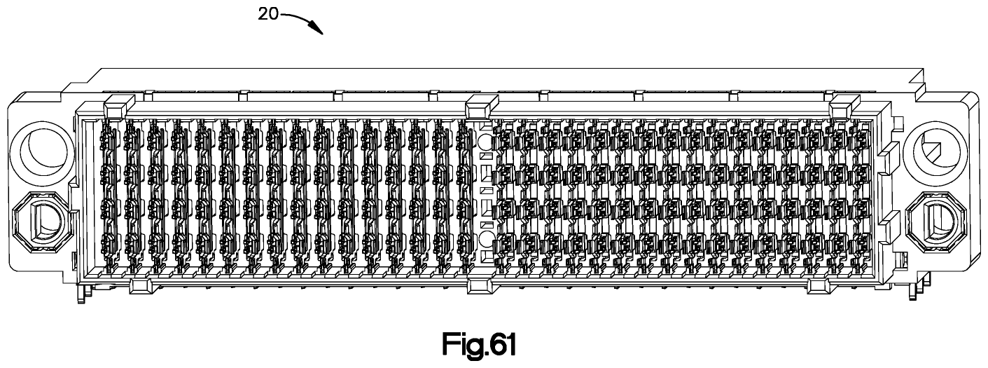

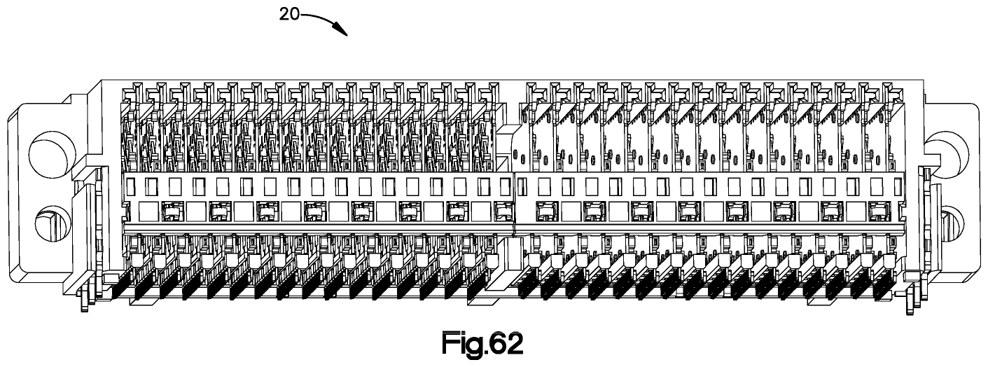

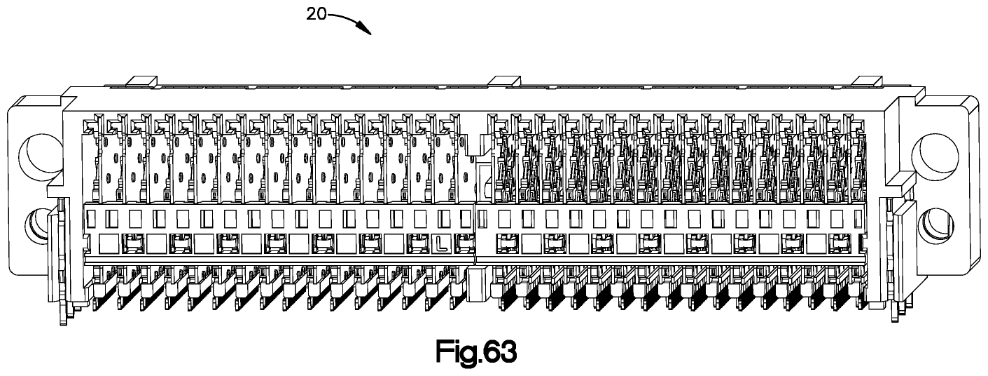

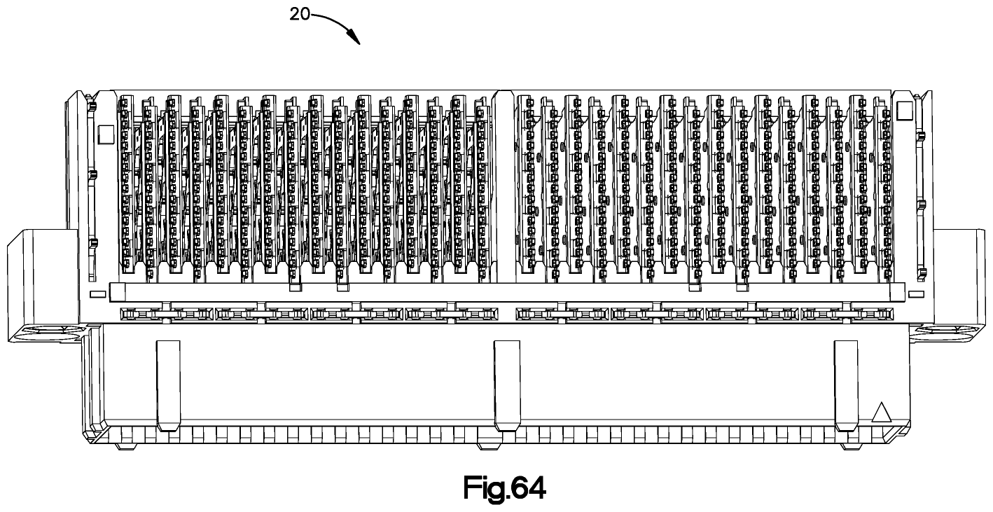

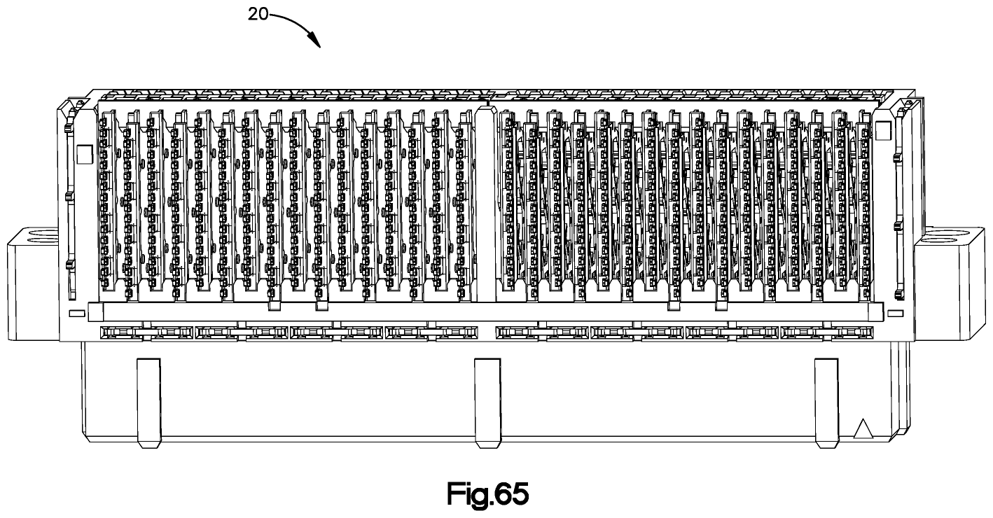

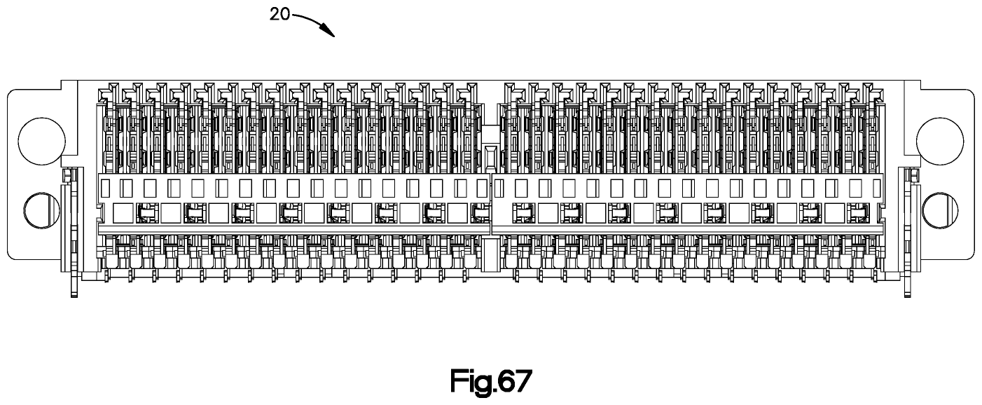

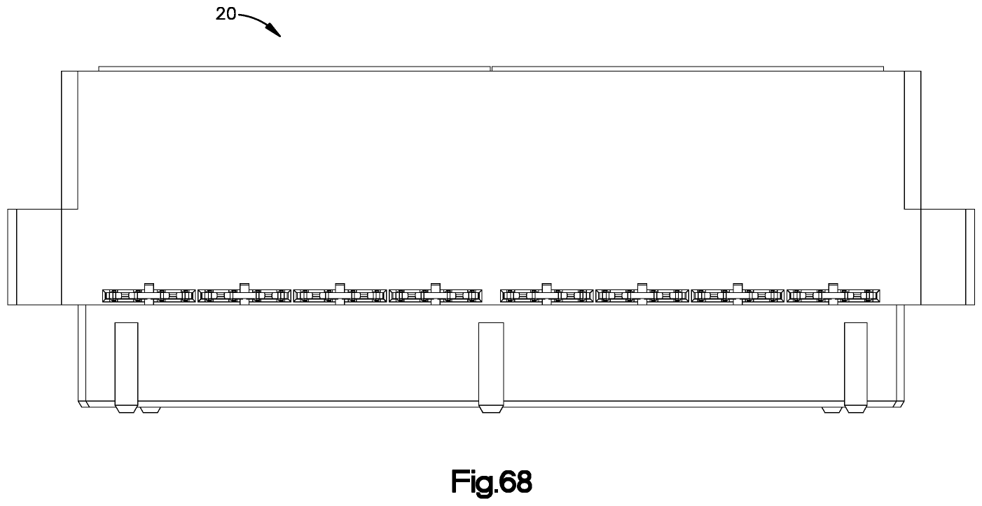

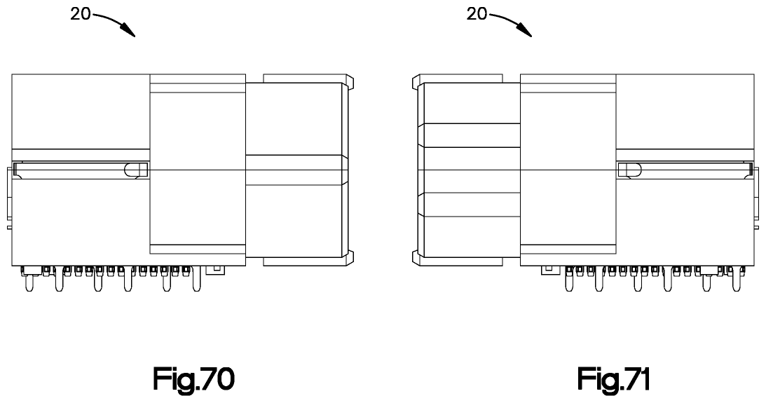

While the electrical connector 20 is described herein with reference to FIGS. 1-11, it is recognized that the principles of the present disclosure, including air gaps, air voids, leadframe assemblies, and the rib described below can apply to other connectors that are differently sized and differently configured (e.g., vertical vs right-angle). For instance, differently sized and differently configured electrical connectors incorporating the principles of the present disclosure are shown in FIGS. 12-71. The electrical connector 20 of FIGS. 12-25 and the electrical connector 20 of FIGS. 26-39 are vertical connectors, while the electrical connector 20 of FIGS. 40-55 and the electrical connector 20 of FIGS. 56-71 are right-angle connectors.

Mating portions 24, which can be referred to as signal mating portions as described in more detail below, and ground mating portions 52 (see FIGS. 3A-3B) can be arranged along respective rows 32 at the mating interface 30. The rows 32 can be oriented along the transverse direction T. Further, the mating portions 24 and 52 can be edge coupled along the transverse direction T. That is, edges of the mating portions 24 and 52 can face each other along the transverse direction T. The electrical contacts 22 can be arranged such that the mating portions 24 and 52 of each row 32 are aligned with respective mating portions 24 and 52, respectively, of each adjacent row 32 along the lateral direction A. Thus, in one example, each mating portion 24 of each row 32 is aligned along the lateral direction A with a respective mating portions 24 of each of the other rows at the mating interface 30. Further, each ground mating portion 52 of each row 32 is aligned along the lateral direction A with a respective ground mating portions 52 of each of the other rows at the mating interface 30. Further, each aligned mating portion along the lateral direction is of a same-type electrical contact 22. For instance, ground mating portions 52 (see FIGS. 3A-3B) are aligned with only other ground mating portions 52 along the lateral direction A. Similarly, the mating portions 24 are aligned with only other mating portions 24 along the lateral direction A. In other words, the rows 32 at the mating interface 30 are not staggered along the longitudinal direction L.

Similarly, mounting portions 26, which can be referred to as signal mounting portions as described in more detail below, and ground mounting portions 54 (see FIG. 3C) can be arranged along respective rows 43 at the mounting interface 34. The rows 43 can be oriented along the longitudinal direction L. Further, the mounting portions 26 and 54 can be edge coupled along the longitudinal direction L. That is, edges of the mounting portions 26 and 54 can face each other along the longitudinal direction L. The electrical contacts 22 can be arranged such that the mounting portions 26 of each row 43 are aligned with respective mounting portions 26 of each adjacent row 43 along the lateral direction A. Thus, in one example, each mounting portion 26 of each row 32 is aligned along the lateral direction A with a respective mounting portion 26 of each of the other rows at the mating interface 30. Further, each ground mounting portion 54 of each row 32 is aligned along the lateral direction A with a respective ground mounting portion 54 of each of the other rows at the mating interface 30. Accordingly, in one example, the arrangement of the mating portions, that is aligned, is the same as the arrangement of the mounting portions, that is aligned. In other words, the rows 43 at the mounting interface 34 are not staggered along the longitudinal direction L. Further, each aligned mounting portion along the lateral direction A is of a same-type electrical contact 22. For instance, ground mounting portions 54 are aligned with only other ground mating portions 52 along the lateral direction A. Similarly, the signal mounting portions 26 are aligned only with other signal mating portions 26 along the lateral direction A.

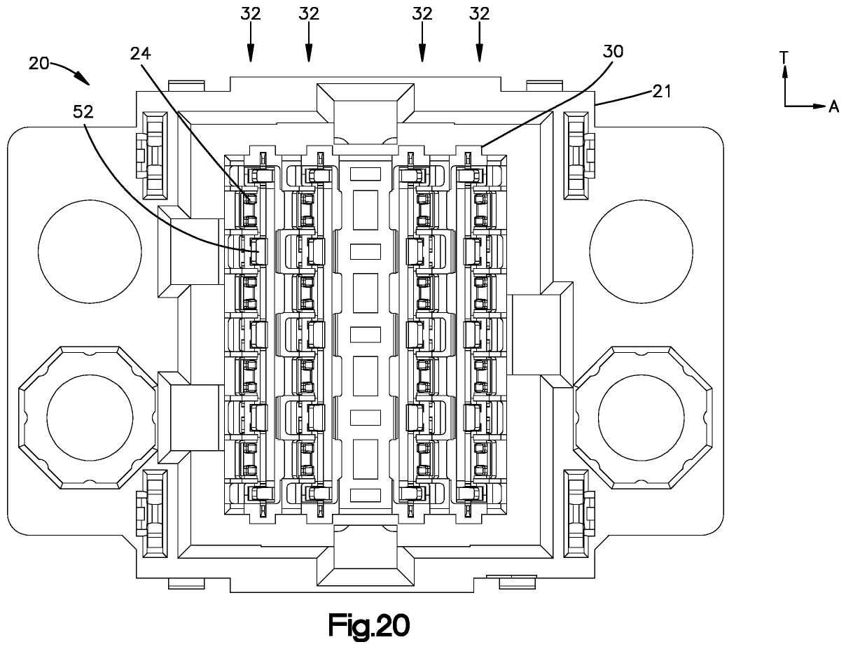

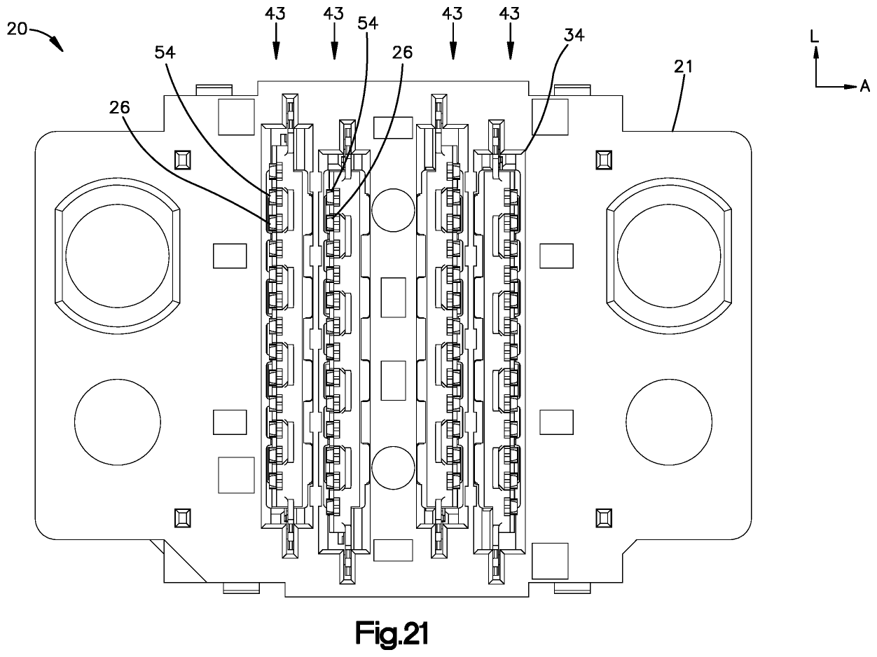

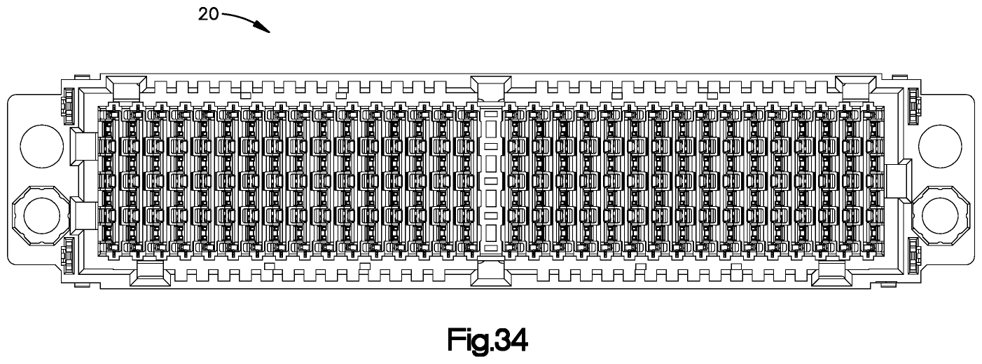

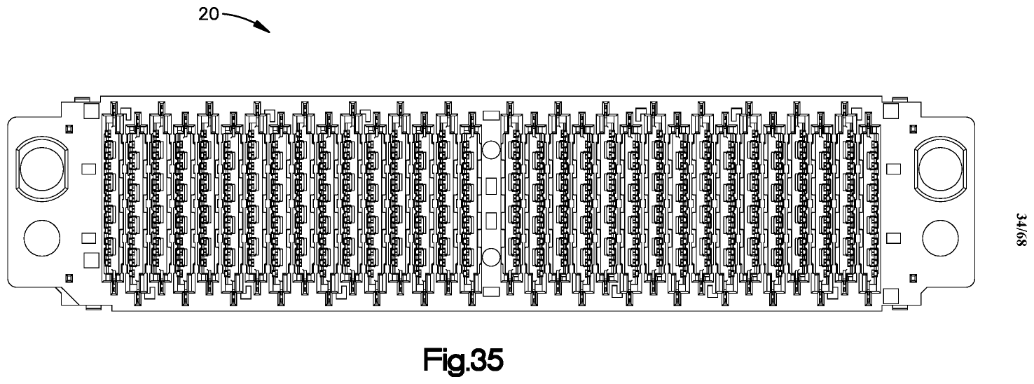

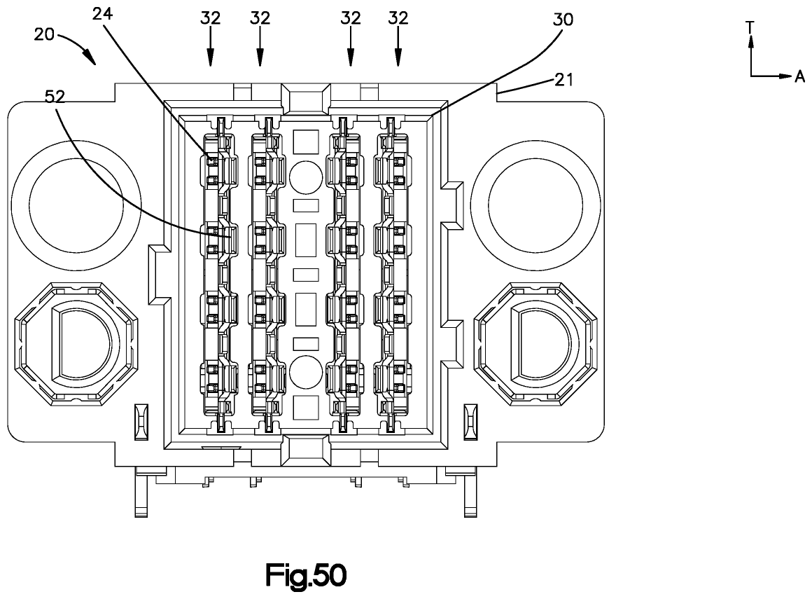

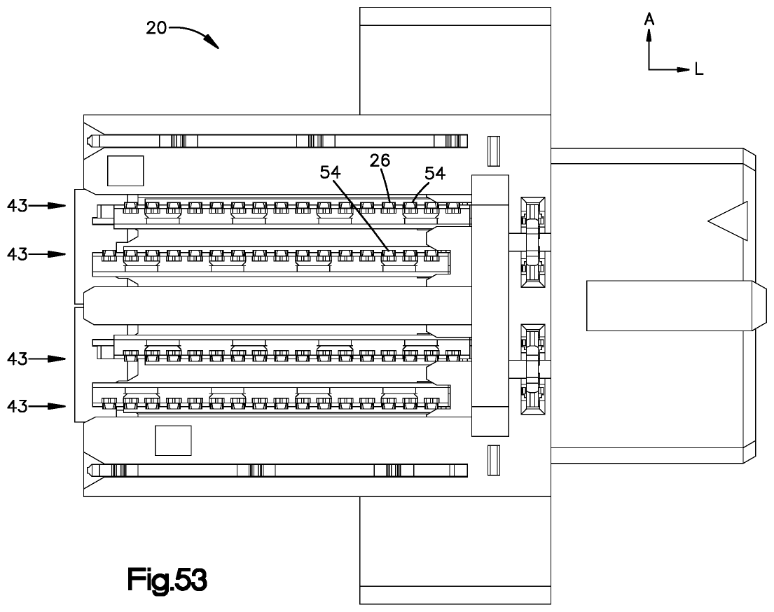

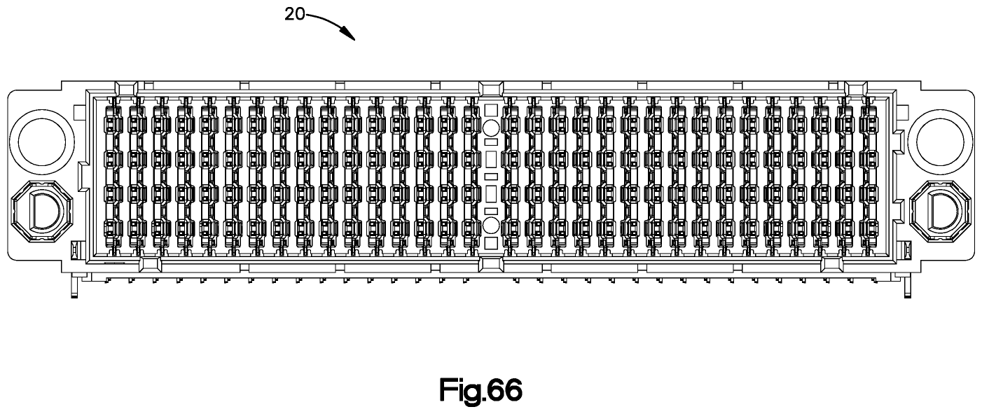

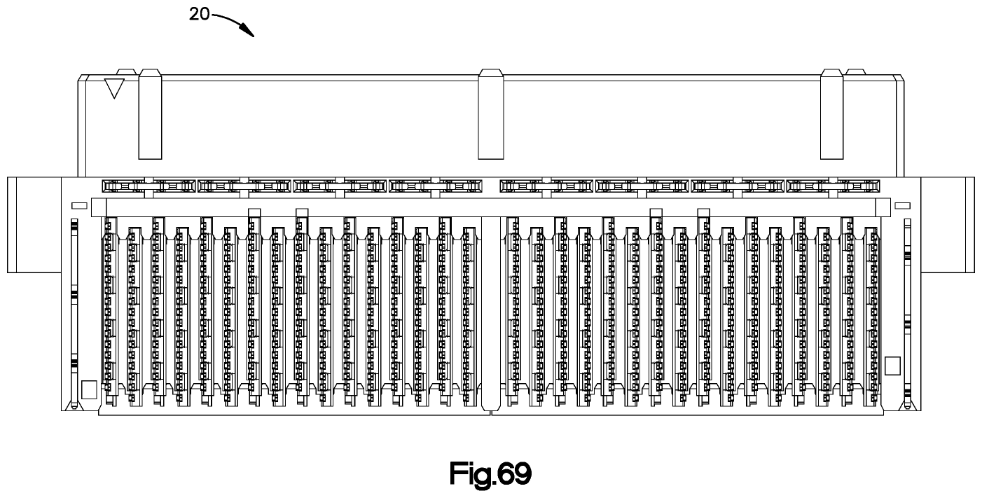

In another example, as shown in FIGS. 12-71 generally, in another example the arrangement of the mating portions can be different than the arrangement of the mounting portions. For instance, the mating portions can be aligned in the manner described above, and the mounting portions can be non-aligned or offset. For instance a vertical electrical connector 20 having an aligned mating interface and a non-aligned or offset mounting interface will be described with reference to FIGS. 20-21. A right-angle electrical connector 20 having an aligned mating interface and a non-aligned or offset mounting interface will be described with reference to FIGS. 50 and 53. An additional example of a vertical electrical connector 20 having an aligned mating interface and a non-aligned or offset mounting interface is shown at FIGS. 34-35. An additional example of a right-angle electrical connector 20 having an aligned mating interface and a non-aligned or offset mounting interface is shown at FIGS. 66 and 69.

Referring now to FIGS. 20-21 and FIGS. 50 and 53, mating portions 24, which can be referred to as signal mating portions as described in more detail below, and ground mating portions 52 can be arranged along respective rows 32 at the mating interface 30. The rows 32 can be oriented along the transverse direction T. Further, the mating portions 24 and 52 can be edge coupled along the transverse direction T. That is, edges of the mating portions 24 and 52 can face each other along the transverse direction T. The electrical contacts 22 can be arranged such that the mating portions 24 and 52 of each row 32 are aligned with respective mating portions 24 and 52, respectively, of each adjacent row 32 along the lateral direction A. Thus, in one example, each mating portion 24 of each row 32 is aligned along the lateral direction A with a respective mating portions 24 of each of the other rows at the mating interface 30. Further, each ground mating portion 52 of each row 32 is aligned along the lateral direction A with a respective ground mating portions 52 of each of the other rows at the mating interface 30. Further, each aligned mating portion along the lateral direction is of a same-type electrical contact 22. For instance, ground mating portions 52 are aligned with only other ground mating portions 52 along the lateral direction A. Similarly, the mating portions 24 are aligned with only other mating portions 24 along the lateral direction A. In other words, the rows 32 at the mating interface 30 are not staggered along the longitudinal direction L.

With continuing reference to FIGS. 20-21 and FIGS. 50 and 53, the mounting portions 26, which can be referred to as signal mounting portions as described in more detail below, and ground mounting portions 54 (see FIG. 3C) can be arranged along respective offset rows 43 at the mounting interface 34. The rows 43 can be oriented along the longitudinal direction L, and at least one up to all of the rows 43 can be offset along the longitudinal direction L with respect to adjacent ones of the rows 43, wherein the adjacent ones of the rows 43 are adjacent along the lateral direction A. Thus, alternating rows 43 along the lateral direction A can be offset with respect to each other along the longitudinal direction L. Every other row along the lateral direction A can be in alignment with each other. The offset rows 43 can be offset any distance as desired. For instance, the offset rows 43 can be offset by a distance equal to a contact pitch along which the mounting portions 26 are spaced along the longitudinal direction L. Therefore, mounting portions of different-type electrical contacts of adjacent offset rows 43 can be aligned along the lateral direction A is of a same-type electrical contact 22. For instance, ground mounting portions 54 can be aligned with signal mounting portions 26 of adjacent rows along the lateral direction A. As described above, the mounting portions 26 can be edge coupled along the longitudinal direction L. That is, edges of the mounting portions 26 and 54 can face each other along the longitudinal direction L. Accordingly, in one example, the arrangement of the mating portions, that is aligned, is different than the arrangement of the mounting portions, that is non-aligned or offset. In other words, the rows 43 at the mounting interface 34 are staggered or offset along the longitudinal direction L.

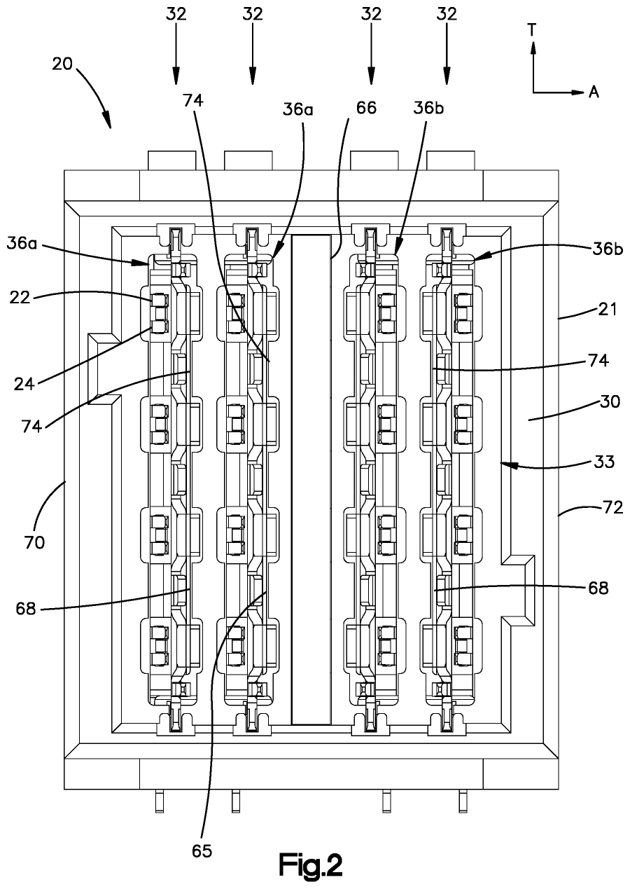

Referring now to FIG. 2-3C, the electrical connector 20 can include a plurality of leadframe assemblies 36 that are supported by the connector housing 21 and spaced from each other along the lateral direction A. Each leadframe assembly 36 includes a respective group of the electrical contacts 22. The mating portions 24 of the electrical contacts 22 of each leadframe assembly 36 can be aligned with each other along the transverse direction T. The mounting portions 26 of the electrical contacts 22 of each leadframe assembly 36 can be aligned with each other along the longitudinal direction L.

Each leadframe assembly 36 can include an electrically insulative leadframe housing 37 that can support the electrical contacts 22 of the leadframe assembly 36. As will be described in more detail below, all the electrical contacts 22 can be configured as signal contacts. In this regard, the electrically insulative leadframe housing 37 and the electrical contacts 22 can, in combination, be referred to as a signal wafer. The electrically insulative leadframe housing 37, and thus the signal wafer, can further be secured to a ground plate 44. Further, the signal wafer can be devoid of electrical ground contacts. The electrically insulative leadframe housing 37 can be made from any suitable electrically nonconductive polymer as desired. For instance, the electrically insulative leadframe housing 37 can be a plastic. In one example, the electrically insulative leadframe housing 37 can include a first electrically insulative leadframe housing portion 38 that supports the electrical contacts 22 of the leadframe assembly 36, a second electrically insulative leadframe housing 56, or both. In this regard, the first electrically insulative leadframe housing portion 38 can be referred to as a contact support housing. While the first electrically insulative leadframe housing portion 38 is shown separate from the electrical contacts 22 in FIG. 3C, it should be appreciated that the electrical contacts 22 can be insert molded in the first electrically insulative leadframe housing portion 38, such that the leadframe assembly 36 can be referred to as an insert molded leadframe assembly (IMLA). Alternatively, the electrical contacts 22 can be stitched into the first electrically insulative leadframe housing portion 38 as desired.

With continuing reference to FIG. 3C, the second electrically insulative leadframe housing 56 can define at least one, at least two, at least three or three or more discrete, adjustable skew correction areas 62, 62A, 62B. A length of each respective adjustable skew correction area 62, 62A, 62B, as measured along the L direction, can be shortened or lengthened to increase or decrease skew in a differential signal pair of electrical contacts 22 that are each positioned immediately adjacent to a respective adjustable skew correction area 62, 62A, 62B. For example, more electrically dielectric material can be added or removed to skew correction area 62, making an overall length of the skew correction area 62 or the electrically non-conductive material that can make up the skew correction area 62 longer or shorter. Stated another way, a method to adjust or balance skew within a differential signal pair of electrical contacts 22 can be tweaked or adjusted or balanced by adding more electrical dielectric material to skew correction area 62 to increase an electrical length of one or both electrical contacts 22 within a differential signal pair or removing existing dielectric material for the skew correction area 62 to decrease an electrical length of one or both electrical contacts 22 withing a differential signal pair. The same can be true for the other skew correction areas 62A and 62B.

The leadframe housing portion 38 can include a plurality of sleeves 39 that receive respective ones of the electrical contacts 22. Thus, the leadframe housing portion 38 can include a number of sleeves that correspond to the number of electrical contacts 22. Further, the sleeves 39 can be shaped to correspond to the shape of the electrical contacts 22. The sleeves 39 of each first electrically insulative leadframe housing portion 38 can be connected to each other, such that the leadframe housing portion 38, including the sleeves 39, can be monolithic with each other. Accordingly, the first electrically insulative leadframe housing portion 38 can define a single unitary structure.

Each leadframe assembly 36 can further include a ground plate 44 that is disposed adjacent the first electrically insulative leadframe housing portion 38. The ground plate 44 can define a first or inner ground plate surface 46 that faces the electrically insulative leadframe housing 37 along the lateral direction A. The first electrically insulative leadframe housing portion 38 defines a first or inner leadframe housing surface 40 that faces the inner ground plate surface 46 of the ground plate, and a second or outer leadframe housing surface 42 opposite the inner leadframe housing surface 40 along the lateral direction A. For instance, the inner leadframe housing surface 40 of each respective leadframe assembly 36 can abut the inner ground plate surface 46 of the respective leadframe assembly 36. Thus, the first or inner ground plate surface 46 also faces the electrical contacts 22 that are supported by the at least one first electrically insulative leadframe housing 37. The ground plate 44 can define a second or outer ground plate surface 48 that is opposite the inner surface along the lateral direction A. Thus, the outer surfaces 42 and 48 of the first electrically insulative leadframe housing portion 38 and the ground plate 44 can face away from each other along the lateral direction A. The ground plate 44 can be formed from any suitable electrically conductive material, such as a metal. The ground plate 44 can include a ground plate body 50, a plurality of ground mating portions 52 that extend from the ground plate body 50 in the forward direction from the body 50 along the transverse direction, and a plurality of ground mounting portions 54 that extend from the body 50 in the downward direction along the transverse direction T. The ground mating portions 52 and the ground mounting portions 54 can be monolithic with each other and the plate body, such that the ground plate 44 is a single unitary structure.

The electrical contacts 22 can be configured as electrical signal contacts, the mating portions 24 can be referred to as signal mating portions, and the mounting portions 26 can be referred to as signal mounting portions. The electrical contacts 22 of each leadframe assembly 36 can define pairs 55 of immediately adjacent electrical contacts. The electrical contacts 22 of each pair 55 can define differential signal pairs in one example. Alternatively, the electrical contacts 22 can be provided as single-ended signal contacts as desired. It should be appreciated that each leadframe assembly 36 can include any number of electrical contacts 22 as desired. Further, the electrical connector 20 can include any number of leadframe assemblies 36 as desired. The pairs 55 of electrical contacts 22 can be separated by a gap 59. The gap 59 can be defined by any suitable dielectric material, such as air, plastic, or both, to separate the electrical contacts 22 of each leadframe assembly 36 from one another.

The ground plate 44 can be electrically conductive. In one example, the ground plate is metallic, and configured to reflect electromagnetic energy produced by the electrical contacts 22 during use, though it should be appreciated that the ground plate 44 can alternatively be an electrically conductive lossy material, or an electrically nonconductive lossy material configured to absorb electromagnetic energy. The ground plate 44 can be aligned with the electrical contacts 22 of the respective leadframe assembly 36 along the lateral direction, and can thus provide electrical shielding of the electrical contacts 22.

The plate body 50 can be spaced from the electrical contacts 22 in a first direction along the lateral direction A. The ground mounting portions 54 of each ground plate 44 can be jogged in a second direction along the lateral direction, such that the ground mounting portions 54 are disposed in the respective 59 between the mounting portions 26 of each pair 55 of electrical contacts 22. Thus, the ground mounting portions 54 can be aligned with the mating portions 26 of the electrical contacts along the longitudinal direction L. Alternatively, the ground mounting portions 54 can be alternatively positioned as desired.

The ground mating portions 52 are configured to mate with respective ground mating portions of the complementary electrical component, such as a complementary electrical connector when the electrical connector 20 is mated with the complementary electrical connector. The ground mating portions 52 can include major ground mating portions 52b and minor ground portions 52a which do not have to mate with a complementary electrical connector ground plate or contacts. The major ground mating portions 52b can have a height that is at least equal to the combined height of the mating portions 24 of each pair 55 of electrical contacts 22, including the gap 59. In one example, the height of the major ground mating portions 52 can be greater than the combined height of the mating portions 24 of each pair 55 of electrical contacts 22, including the gap 59. Further, the major ground mating portions 52b can extend forward from the plate body 50 to a location that is at least as far forward as the forwardmost ends of the mating portions 24 of the electrical contacts 22. Therefore, each major ground mating portion 52b can be aligned with the mating portions 24 of a respective one of the pair 55 of electrical contacts 55 of the same leadframe assembly 36 along the lateral direction A. Accordingly, the major ground mating portions 52b can provide electrical shielding for the mating portions 24. The major ground mating portions 52b can jog from the plate body 50 in an outward direction that is defined as extending along the lateral direction from the inner ground plate surface 46 to the outer ground plate surface 48 of the plate body 50.

The minor ground portions 52a can extend forward from the plate body 50 to a position that is recessed from the forwardmost end of the major ground mating portions 52b in the rearward direction. The minor ground portions 52a can be aligned with the gaps 59 between the pairs 55 of mating portions 24 along the lateral direction A. The minor ground portions 52a can be substantially coplanar with the plate body 50, such that the minor ground portions 52a are offset with respect to the major ground mating portions 52b in the outward direction.

The ground plate 44 can be discretely attached to the at least one leadframe housing 37 or insert molded in the at least one leadframe housing 37. In one example, the electrically insulative leadframe housing 37 can include a second electrically insulative leadframe housing portion 56 that is sized and configured to be positioned such that the first electrically insulative leadframe housing portion 38 is disposed between the second electrically insulative leadframe housing portion 56 and the ground plate 44 with respect to the lateral direction A. Stated another way, the second electrically insulative leadframe housing 56 can attach the electrically insulative leadframe housing 37 to the ground plate 44. The second electrically insulative leadframe housing 56 can be formed by a second overmolding process. The second electrically insulative leadframe housing portion 56 can be secured to the ground plate 44 so as to capture the first electrically insulative leadframe housing portion 38 between the second electrically insulative leadframe housing portion 56 and the ground plate 44. The securement housing portion 56 can be secured to the ground plate 44 using any suitable fastener 61 which can be defined by overmolded plastic of the leadframe housing 37, or can be find my any suitable alternative mechanical fastener or the like. In this regard, the second electrically insulative leadframe housing portion 56 can be referred to as a securement housing.

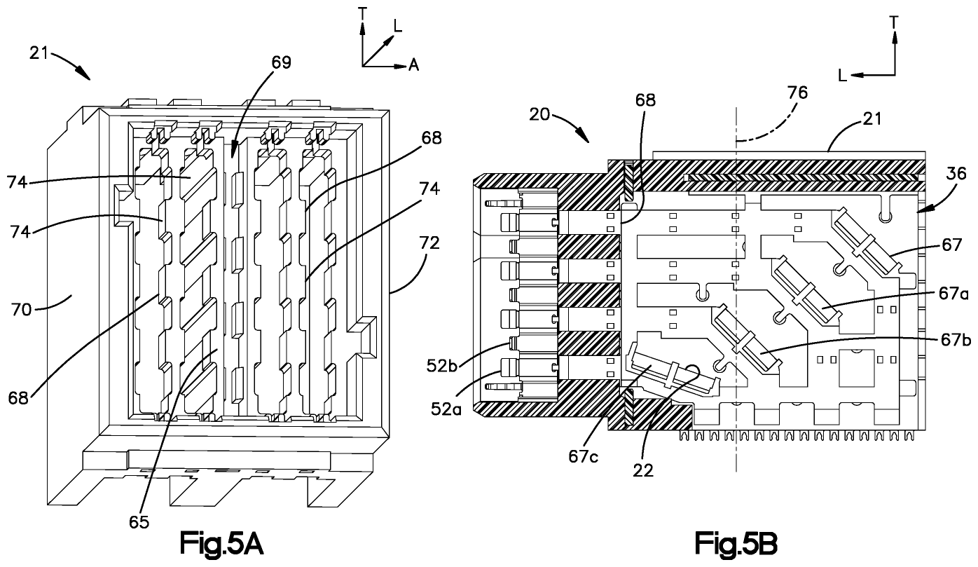

The first and second housing portions 38 and 56 can be separate from each other and either attached to each other, or the first housing portion 38 can be insert molded in the second housing portion 56. Alternatively, the electrically insulative leadframe housing 37 be configured as a single housing having a single monolithic structure. Thus, the first electrically insulative leadframe housing portion 38 and the second electrically insulative leadframe housing portion 56 can define a single monolithic structure that defines the electrically insulative leadframe housing 37. The ground plate 44 can be insert molded in the leadframe housing 37, such that the fasteners 61 are overmolded portions of the leadframe housing 37 that secure the ground plate 44 to the leadframe housing 37. The leadframe housing 37 can also define an abutment member 63 that extends along the outer surface of the ground plate 44. The abutment member 63 can abut spacer ribs 68 (see FIG. 5A) so as to assist in positioning and securing the leadframe assembly 36 in the connector housing 21, as described in more detail below. Thus, the leadframe housing 37 can extend along respective portions of both the inner portion 46 and the outer portion 48 of the ground plate 44.

Referring now to FIGS. 3A-4, the leadframe assemblies 36 can be supported in the connector housing 21 in any suitable manner as desired. In one example, the connector housing 22 can include a plurality of channels 58 each configured to receive a corresponding one of the leadframe assemblies 36 so as to support the leadframe assemblies 36 in the connector housing 21. The channels 58 can be open to the rear end of the connector housing 21. Thus, the leadframe assemblies 36 can be inserted into respective ones of the channels 58 at the rear end of the connector housing 21 and translated in the forward direction until the leadframe assemblies 36 are fully seated in the connector housing 21.

In one example, each channel 58 can include a transverse portion 60 that extends along the transverse direction T into the housing 21, and is elongate along the longitudinal direction L. The transverse portion 60 can be open at the rear and of the connector housing 21. The transverse portion 60 can be configured to receive the ground plate 44. In one example, the transverse channel 60 extends into an upper and of the connector housing 21 in an upward direction opposite the downward direction and away from the bottom surface of the connector housing 21. Thus, the transverse channel 50 can be configured to receive an upper end of the ground plate 44 that is opposite the ground mounting portions 54. The channel 58 can further include a lateral portion 62 that extends from the transverse portion 60 into the connector housing 21 along the lateral direction A. The lateral portion 62 is configured to receive a rail 64 of the at least one leadframe housing 37. In particular, the second electrically insulative leadframe housing portion 56 can include a projection that defines the rail 64 that extends in the lateral direction A with respect to the ground plate 44 and is received in the lateral portion 62 of the channel 58. When the at least one leadframe housing 37 defines a single leadframe housing, the single leadframe housing can define the rail 64.

It should be appreciated that the channels 58 can define any suitable alternative shape designed to receive any suitable portion of the leadframe assemblies 36 so as to secure the leadframe assemblies 36 to the connector housing 21. It should further be appreciated that the leadframe assemblies 36 can be inserted into the front of the connector housing 21 and translated along the channels 58 in the rearward direction until the leadframe assemblies 36 are fully seated in the connector housing 21. Alternatively, the leadframe assemblies 36 can be secured in the connector housing 21 in any suitable alternative manner as desired. For instance, the leadframe assemblies 36 can be loaded into the bottom of the connector housing 21, and secured to the leadframe housing in any manner as desired.

The leadframe assemblies 36 can include a first group 36a of leadframe assemblies 36 and a second group 36b of leadframe assemblies 36. The first group 36a of leadframe assemblies 36 can be mirror images of the second group 36b of leadframe assemblies 36 along a plane 39 that is disposed between the first and second groups 36a and 36b. The plane can be oriented along the transverse direction T and the longitudinal direction L. Further, the plane can bisect the connector housing 21 with respect to the lateral direction A. In particular, the leadframe assemblies 36 can be configured such that the outer surfaces 48 of the ground plates 44 of each of the first and second groups 36a and 36b face toward the plane 39. During operation, the electrical contacts 22 of the first group 36a of leadframe assemblies can be configured to transmit electrical signals in a first direction, and the electrical contacts 22 of the second group 36b of leadframe assemblies can be configured to transmit electrical signals in a second direction opposite the first direction. For instance, the first direction of electrical signal transmission can be from the mating portions 24 to the mounting portions 26 (and thus from the complementary electrical connector to the substrate 25). The second direction of electrical signal transmission can be from the mounting portions 26 to the mating portions 24 (and thus from the substrate 25 to the complementary electrical connector). The first group 36a of leadframe assemblies can all be disposed on a first side of the plane 39 with respect to the lateral direction A, such that none of the second group 36b of leadframe assemblies 36 are disposed at the first side of the plane 39. Similarly, the second group 36b of leadframe assemblies can all be disposed on a second side of the plane 39 opposite the first side with respect to the lateral direction A, such that none of the first group 36a of leadframe assemblies 36 are disposed at the second side of the plane 39.

Referring now to FIGS. 5A-7, the electrical connector 21 can include a shield 66 that is disposed between the first group 36a of leadframe assemblies 36 and the second group 36b of leadframe assemblies 36 with respect to the lateral direction A. The shield 66 can be disposed along the plane 39 (see FIG. 4). For instance, the plane 39 can bisect the shield 66 with respect to the lateral direction A. The shield 66 can span an entirety of a cumulative height of all of the mating portions 24 of the electrical contacts 22. Thus, in one example none of the mating portions 24 are offset with respect to the shield 66 in the downward direction or the upward direction. The connector housing 21 can define a divider rib 65 that is centrally disposed with respect to the lateral direction A, and thus is disposed between the first group 36a of leadframe assemblies 36 and the second group 36b of leadframe assemblies 36. The divider rib 65 can extend along the transverse direction T from the bottom of the connector housing 21 to the top of the connector housing 21. Further, the divider rib 65 can extend in the forward direction from the rear of the connector housing 21 to a location rearwardly recessed with respect to the front end of the connector housing 21 in one example. It should be appreciated that the divider rib 65 can define any suitable alternative size and shape as desired.

The electrical connector 20 can define a pocket 69 that extends into the front end of the divider rib 65, and the shield 66 can be disposed in the pocket 69. The pocket 69 can extend into the divider rib 65 in the rearward direction, and can extend along less than half the overall length of the connector housing 21 along the longitudinal direction. It should be appreciated, of course, that the pocket 69 can have any alternative size and shape as desired. In one example, the shield 66 can be substantially flush with the front end of the connector housing 21, such that the mating portions 24 extend forward from the shield 66.

The shield 66 can be tuned to absorb magnetic field at a frequency or range of frequencies. For example, the shield 66 can have material properties tuned to absorb magnetic field substantially at the operating frequency of the electrical connector 20. The word “substantially” with respect to frequency includes the frequencies stated herein along with frequencies within five GHz above the stated frequency and five GHz below the stated frequency (+/−5 GHZ). It should be appreciated, of course, that the shield 66 can be configured to attenuate other frequencies as desired. For example, the shield 66 can be made from a broad-band or narrow band absorber or can include or carry a broad-band or narrow band absorber. The shield 66 can be tuned to attenuate a band of frequencies broader than 1 GHz, broader than 10 GHZ, broader than 20 GHz, broader than 30 GHz, broader than 40 GHz, broader than 50 GHz, broader than 60 GHz, broader than 70 GHz, broader than 80 GHz, broader than 90 GHZ, or broader than 100 GHz.

The shield 66 can include a plate formed from an electrically conductive or electrically non-conductive material that can be embedded in, or otherwise covered by, a lossy material or a metamaterial. The shield 66 can be physically isolated from all ground plates 44, such that the shield 66 is not electrically conductively coupled to any grounds. Thus, the shield 66 can be referred to as an ungrounded shield. The lossy material or metamaterial can be magnetically absorbing. In one example, the lossy material or metamaterial can be electrically conductive. For instance, lossy material or metamaterial can have an electrical conductivity greater than 1 Siemens per meter up to substantially 6.1 times 10\hat{ }7 Siemens per meter. Alternatively, the lossy material or metamaterial can be electrically nonconductive. For instance, the lossy material or metamaterial can have an electrical conductivity that ranges from 1 Siemens per meter to substantially 1 times 10\hat{ }-17 Siemens per meter. Without being bound by theory, it is believed that the lossy material or metamaterial can improve signal integrity over a comparable design where the substrate or plate, or where an ungrounded substrate or plate, is not embedded with or covered by the lossy material or metamaterial. Connectors of the present disclosure can be capable of meeting the 32 gigabits/second PCIE Express Gen 5 standard without the shield 66 or can be compatible with 56 gigabits/second NRZ or 112 gigabits/second PAM4 when implemented with the shield 66. Without being bound by theory, it is believed that the shield 66 can result in operation of the electrical connector 20 at lower levels of cross-talk at higher frequencies.

The shield 66 can be configured as described in any one or more up to all of International Patent Application Serial No. PCT/US2020/031099 filed May 1, 2020 and International Patent Application Serial No. PCT/US2019/041576 filed Jul. 12, 2019, the disclosure of each of which is hereby incorporated by reference as if set forth in its entirety herein.

The outer surfaces 48 of the ground plates 44 of the first group 36a of leadframe assemblies 36 can face the electrical shield 66, and the outer ground plate surface 48 of the second group 36b of leadframe assemblies 36 can face the electrical shield 66. When the electrical connector 21 is mated with the complementary electrical connector, the electrical shield 66 can abut a complementary shield of the complementary electrical connector, such that the mating portions 24 of the electrical contacts and the mating portions of the complementary electrical contacts are shielded by the electrical shield 66 and the complementary shield when the electrical connectors are mated to each other.

Referring now to FIGS. 2 and 5A in particular, the connector housing 21 can further include spacer ribs 68 that are disposed between the divider rib 65 and one of opposed first and second lateral sides 70 and 72 of the connector housing 21. In particular, the ribs 68 can include a first group 68a of at least one rib 68 disposed between the divider rib 65 and the first lateral side 70 of the connector housing 21. The ribs 68 can include a second group 68b of at least one rib 68 disposed between the divider rib 65 and the second lateral side 72 of the connector housing 21.

An innermost one of the first group 36a of leadframe assemblies 36 can be captured between an innermost one of the first group 68a of ribs 68 and the divider rib 65 with respect to the lateral direction A. An outermost one of the first group 36a of leadframe assemblies 36 can be captured between an outermost one of the first group 68a of ribs and the first lateral side 70 with respect to the lateral direction A. At least one of the first group 68a of ribs can be disposed between adjacent ones of a pair of the first group 36a of leadframe assemblies 36. In one example, the first group 68a of ribs 68 can contact the at least one leadframe housing 37 to assist in securing the first group 36a of leadframe assemblies 36 in the connector housing 21. If desired, depending on the number of leadframe assemblies 36 included in the electrical connector, one or more of the first group 36a of leadframe assemblies can be captured between respective immediately adjacent pairs of the first group 68a of ribs 68 with respect to the lateral direction A.

Similarly, an innermost one of the second group 36b of leadframe assemblies 36 can be captured between an innermost one of the second group 68b of ribs 68 and the divider rib 65 with respect to the lateral direction A. An outermost one of the second group 36b of leadframe assemblies 36 can be captured between an outermost one of the second group 68b of ribs and the second lateral side 72 with respect to the lateral direction A. At least one of the second group 68b of ribs 68 can be disposed between adjacent ones of a pair of the second group 36b of leadframe assemblies 36. In one example, the second group 68b of ribs 68 can contact the at least one leadframe housing 37 to assist in securing the second group 36b of leadframe assemblies 36 in the connector housing 21. If desired, depending on the number of leadframe assemblies 36 included in the electrical connector 20, one or more of the second group 36b of leadframe assemblies can be captured between respective immediately adjacent pairs of the second group 68b of ribs 68 with respect to the lateral direction A.

The divider rib 65 and the spacer ribs 68 can include any surface texture as desired. For instance, the opposed lateral surfaces of the divider rib 65 and the spacer ribs 68 can define ridges 74 that are oriented along the lateral direction A and alternatingly arranged along the transverse direction T. It should be appreciated that the ridges 74 can define any suitable alternative size and shape. In one example, the ridges 74 can be oriented along the transverse direction T and alternatingly arranged along the longitudinal direction L. The ridges 74 can abut opposed sides of the leadframe assemblies 36 when the leadframe assemblies 36 are disposed in the connector housing 21, and thus assist in securement of the leadframe assemblies in the connector housing 21.

Referring now to FIGS. 4-5B, the spacer ribs 68 each define a front end 68a and a rear end 68b opposite the front end 68a along the longitudinal direction L. The divider rib 65 can similarly define a front end 65a and a rear end 65b opposite the front end 65a along the longitudinal direction L. The front ends 68a and 65a can be aligned with each other along the lateral direction A. Further, the front ends 68a and 65a can lie in a common plane that is defined by the lateral direction A and the transverse direction T. The spacer ribs 68 can each have a respective length along the longitudinal direction L from the front end 68a to the rear end 68b. The divider rib 65 can have a respective length along the longitudinal direction L from the front end 68a to the rear end 68b that is substantially equal (within manufacturing tolerances) to the length of the connector housing 21 from the front end to the rear end. Thus, comparisons of the length of the spacer ribs 68 along the longitudinal direction L to the connector housing 21 can apply with equal force and effect to the divider rib 65.

The length of the spacer ribs 68 can be less than the length of the connector housing 21. For instance, the length of the spacer ribs 68 can be less than one-half the length of the connector housing 21, such as less than one-third of the length of the connector housing 21, such as less than one-fourth of the length of the connector housing 21, less than one-fifth of the length of the connector housing 21, less than one-sixth of the length of the connector housing 21, less than one-seventh the length of the connector housing 21, or less than one-eighth of the length of the connector housing 21. In one example, the spacer ribs 68 can be entirely contained between a midplane 76 of the connector housing 21 and the front end of the connector housing 21. The midplane 76 can be oriented along the transverse direction T and the lateral direction A, and bisects the connector housing 21 with respect to the longitudinal direction L. It should be appreciated, of course, that the spacer ribs 68 can be positioned anywhere along the housing 21. In other examples, the connector housing 21 can be devoid of spacer ribs.

Accordingly, the spacer ribs 68 can be disposed between the adjacent leadframe assemblies 36 of respective pairs of leadframe assemblies 36 with respect to the lateral direction A. The spacer ribs 68 can contact the respective leadframe assemblies 36. Thus, the spacer ribs 68 can be aligned with a portion less than an entirety of adjacent ones of respective pairs of leadframe assemblies 36 along the lateral direction A. The length of the spacer ribs 68 can be less than to the length of the connector housing 21. In one example, the length of the spacer ribs 68 can be less than one-half the length of the leadframe assemblies 36, such as less than one-third of the length of the leadframe assemblies 36, such as less than one-fourth of the length of the leadframe assemblies 36, less than one-fifth of the length of the leadframe assemblies 36, less than one-sixth of the length of the leadframe assemblies 36, less than one-seventh the length of the leadframe assemblies 36, or less than one-eighth of the length of the leadframe assemblies 36.

It should therefore be appreciated that at least a portion of the leadframe assemblies 36 of the pair of immediately adjacent first and second leadframe assemblies can be separated by a gap 78 along the lateral direction A. Immediately adjacent leadframe assemblies 36 do not have any leadframe assemblies or additional shields between each other. The leadframe housing 37 of the first leadframe assembly of the pair of leadframe assemblies 36 can extend from the ground plate 44 of the first leadframe assembly of the pair of leadframe assemblies 36 along the lateral direction A toward the ground plate 44 of the second leadframe assembly of the pair of leadframe assemblies. Further, the electrical signal contacts 22 of the first leadframe assembly are closer to the ground plate of the first leadframe assembly along the lateral direction A than they are to the ground plate of the second leadframe assembly along the lateral direction A.

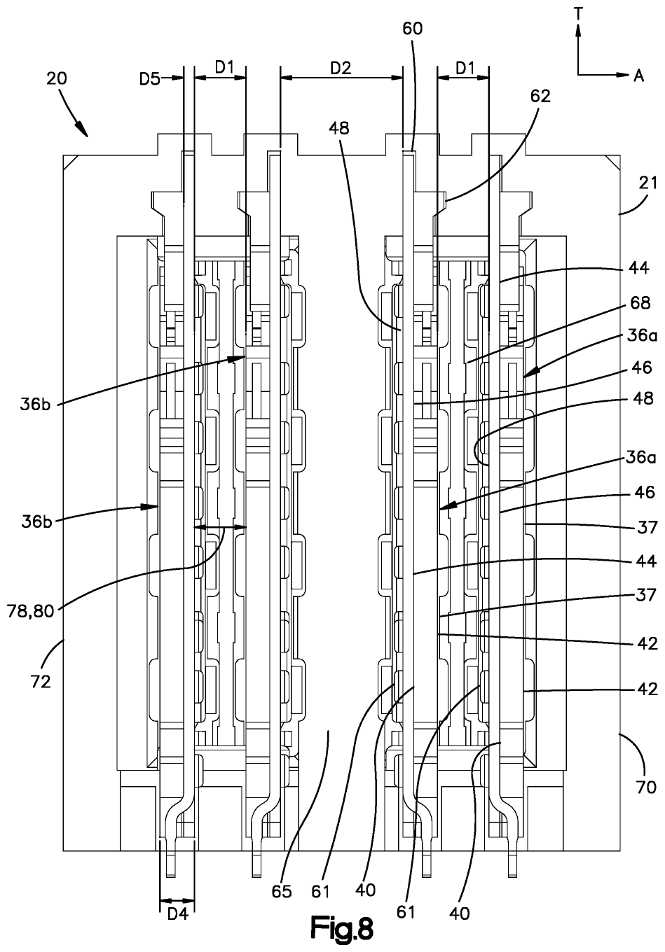

A first portion of the gap 78 can be occupied by a respective one of the spacer ribs 68. A second portion of the gap 78 can be unfilled, and thus can define an air gap 80 (see FIG. 8). In other examples, the electrical connector 20 can be devoid of the spacer ribs 68, such that an entirety of the gap 78 between the leadframe assemblies 36 of the pair of leadframe assemblies can be substantially entirely defined by the air gap 80. Thus, it can be said that at least respective portions of the leadframe assemblies 36 of the pair of leadframe assemblies can be separated by the air gap 80. For instance, respective majorities of the leadframe assemblies 36 of the pair of leadframe assemblies can be separated by the air gap 80. In one example, at least approximately 50 percent, such as at least 75 percent, such as at least 80 percent, such as at least 90 percent of each of the leadframe assemblies 36 of the pair of leadframe assemblies can be separated by the air gap 80.

The air gap 80 can be aligned with a portion, such as a majority of the electrical contacts 22 along the lateral direction A, including the intermediate portions 28. The air gap 80 can define a first distance D1 that extends along the lateral direction from the outer ground plate surface 48 of the ground plate 44 of the first leadframe assembly 36 of the pair of leadframe assemblies 36 to the electrically insulative housing 37 of the second leadframe assembly 36 of the pair of leadframe assemblies 36. Thus, in one example, the first distance D1 can be oriented substantially (within manufacturing tolerances) perpendicular to the outer ground plate surface 48 of the ground plate of the first leadframe assembly 36 of the pair of leadframe assemblies, and can be oriented substantially (within manufacturing tolerances) perpendicular to the surface of the electrically insulative leadframe housing 37 of the second leadframe assembly 36 of the pair of leadframe assemblies that faces the outer ground plate surface 48 of the ground plate 44 of the first leadframe assembly 36 of the pair of leadframe assemblies. Without being bound by theory, it is understood that air is a dielectric that can reduce cross-talk of the electrical connector with respect to conventional electrically insulative plastic.

The first distance D1 can be in a range from approximately 0.8 mm to approximately 3.5 mm, 1 mm to approximately 3 mm or approximately 1.2 mm inch to approximately 2.8 mm or can be approximately 1.2 mm.

Thus, in one example, the first dimension D1 can be in a range of any one of approximately 0.8±0.05 mm, 0.9±0.05 mm, 1±0.05 mm, 1.1±0.05 mm, 1.2 mm, 1.2±0.05 mm, 1.3=0.05 mm, 1.4±0.05 mm, 1.5±0.05 mm, 1.6±0.05 mm, 1.7±0.05 mm, 1.8±0.05 mm, 1.9±0.05 mm, 2±0.05 mm, 2.1±0.05 mm, 2.2±0.05 mm, 2.3±0.05 mm, 2.4±0.05 mm, 2.5±0.05 mm, 2.6±0.05 mm, 2.7±0.05 mm, 2.8±0.05 mm, 2.9±0.05 mm, 3=0.05 mm, 3.1±0.05 mm, 3.2±0.05 mm, 3.3±0.05 mm, 3.4±0.05 mm, and 3.5±0.05 mm.

It should be appreciated that the above are examples of the first dimension D1, and that the first dimension D1 can vary as desired depending on the amount of electrical isolation desired between adjacent leadframe assemblies 36. The first distance D1 can be the maximum distance along the lateral direction A from the outer ground plate surface 48 of the ground plate 44 of the first leadframe assembly 36 of the pair of leadframe assemblies to the electrically insulative housing 37 of the second leadframe assembly 36 of the pair of leadframe assemblies, it being recognized that the surface of the electrically insulative housing 37 of the second leadframe assembly 36 that faces the outer ground plate surface 48 of the ground plate 44 first leadframe assembly 36 need not be smooth. In one example, the majority of the outer ground plate surface 48 of the ground plate 44 of the first leadframe assembly 36 of the pair of leadframe assemblies and the majority of the surface of the electrically insulative leadframe housing 37 of the second leadframe assembly 36 of the pair of leadframe assemblies can define the first distance D1.

The electrical connector 20 can further include a second distance D2 that is defined by the width of the divider rib 65 along the lateral direction A. Thus, the second distance D2 can separate the first group 36a of leadframe assemblies 36 from the second group 36b of leadframe assemblies 36. Otherwise stated, the distance D2 can define a distance from the innermost ones of the first group 36a of leadframe assemblies 36 from the innermost one of the second group 36b of leadframe assemblies 36. The first distance D1 can be less than the second distance D2. For instance, the first distance D1 can be from approximately 20% to approximately 90% of the second distance D2, such as from approximately 30% to approximately 88% of the second distance D2, for instance from approximately 40% to approximately 70% of the second distance D2, including from approximately 50% to approximately 60% of the second distance D2. In one example, the first distance D1 can be approximately 55% of the second distance D2. It is recognized that the second distance D2 can be dimensioned as described above, or can define any suitable alternative distance as desired, depending on the desired size of the gap between the first group 36a of leadframe assemblies 36 and the second group 36b of leadframe assemblies 36.

As shown in FIG. 5B, at least one, at least two, at least three, at least four, or four or more skew compensation voids or air voids 67, 67A, 67B, 67C can be defined over or adjacent to one electrical contact 22 of a differential signal pair. One electrical contact 22 of the differential signal pair can be exposed to air within the respective air void 67, 67A, 67B, 67B. In theory, both electrical contacts 22 can be at least partially exposed to air or have a respective skew compensation or corresponding air void 67, 67A, 67B, 67C along respective lengths of the electrical contacts 22. An electrical contact 22 can have an exposed contact area, or an area of the electrical contact exposed to air or other dielectric numerically close to air, partially along its entire physical length.

At least two or at least three of the respective air voids 67, 67A, 67B, 67C can have equal or substantially equal or approximately equal areas. At least two, at least three, or at least four of the respective air voids 67, 67A, 67B, 67C can form identical or substantially identical or approximately identical perimeters or geometrical shapes. The air void 67 closest in distance to the physically longest differential signal pair of electrical contacts 22 can have an area of air or an exposed area or an exposed area bounded by an electrical non-conductive material that is numerically smaller that the air void 67C that is closest in distance to the physically shortest differential signal pair of electrical contact 22. Stated another way, the air voids 67, 67A, 67B, 67C can, counting sequentially from the longest differential signal pair of electrical contacts 22 to the shortest differential pair of electrical contacts 22, can maintain substantially numerically identical exposed areas or volumes of air or can increase in exposed areas or volumes of air. For example, air voids 67 and 67A can each have the same exposed areas or volumes. Alternatively, air void 67A can be larger in exposed area or volume than air void 67. Air void 67B can have the same exposed area or volume as one or both of air voids 67, 67A or be larger in exposed area or volume than air void 67, air void 67A or both individual air voids 67, 67A. Air void 67C can have the same exposed area or volume as one or more of air voids 67, 67A, 67B or be larger in exposed area or volume than air void 67, air void 67A, air void 67B or any one or more of individual air voids 67, 67A, 67B. As shown, air voids 67, 67A, 67B each have the same or approximately the same, within manufacturing tolerances, exposed areas or volumes. Air void 67B has a larger exposed area or volume than any one of air voids 67, 67A, 67B. Skew can be corrected or tweaked or modified or adjusted by making any respective air void 67, 67A, 67B, 67C or any corresponding exposed area (to air) of one or maybe both electrical contacts 22 in a differential signal pair numerically larger or smaller, or by making a respective air void 67, 67A, 67B, 67C longer or shorter along a respective electrical contact 22. Generally, taking away electrically non-conductive material along a transmission path or direction of a respective physical length of electrical contact 22 of a differential signal or exposing more the respective electrical contact 22 to air increase signal a signal propagation speed along the respective electrical contact 22. Adding more electrically non-conductive material or exposing less of the respective electrical contact 22 of a differential signal pair to air decreases signal propagation speed along the respective physical length of the electrical contact 22. In practice, in a right angle connector, one electrical contact 22 has a longer physical length than the corresponding electrical contact 22 in the same differential signal pair. Adding more air to or along the longer electrical contact 22 in the differential signal pair can speed up the signal propagating along the longer electrical contact 22 so that the electrical lengths of both electrical contacts 22 of the differential signal pair can be approximately equal.

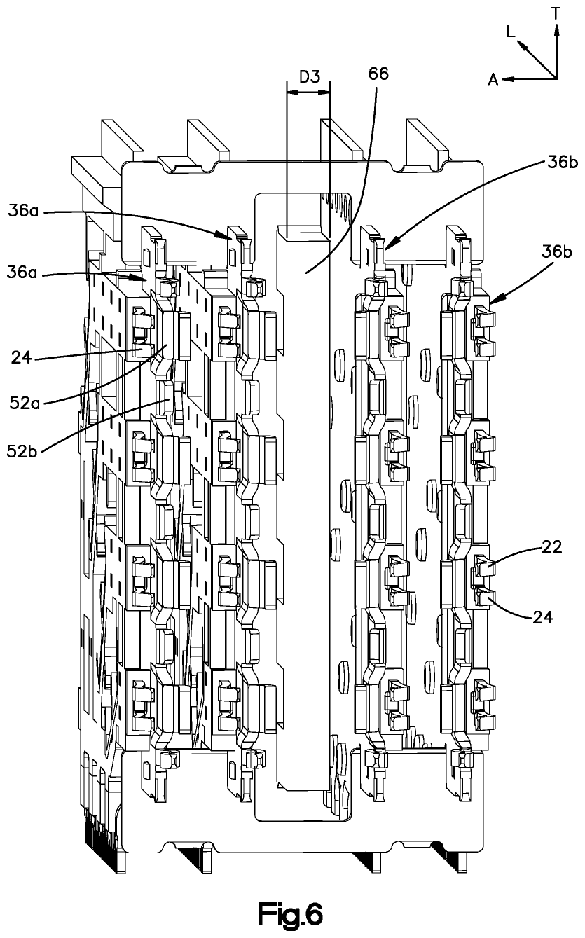

Referring now also to FIG. 6, it is recognized that the shield 66 can be disposed in the divider rib 65, and thus can have a shield width along the lateral direction A that defines a third distance D3 that is less than the second distance D2 that is defined by the width of the divider rib 65. The first distance D1 can be greater than, less than or greater than the third distance D3 as desired. It is recognized that the third distance D3 can be dimensioned as described above, or can define any suitable alternative distance as desired, depending on the desired size of the shield 66 that separates the first group 36a of leadframe assemblies 36 from the second group 36b of leadframe assemblies 36.

Referring now also to FIG. 8, each of the leadframe assemblies 36 can have a respective leadframe housing width that can be defined by a fourth distance D4. The width, and thus the fourth distance D4, can be measured from the outer ground plate surface 48 of the ground plate 44 to the outer leadframe housing surface 42 of the leadframe housing 37. The width does not or may not include the localized fasteners 61 that secure the leadframe housing 37 to the ground plate 44, and can protrude out from the inner and outer surfaces 40 and 42, as the fasteners 61 can be configured to have any width as desired. Thus, the inner and outer surfaces 40 and 42 of the leadframe housing 37 can be substantially planar. The first distance D1 can be greater than, equal to or less than the fourth distance D4 as desired. In one example, the first distance D1 can be in a range from approximately 10% greater than the fourth distance D4 to approximately 60% of the fourth distance D4. It is recognized that the fourth distance D4 can be dimensioned as described above, or can define any suitable alternative distance as desired.

With continuing reference to FIG. 8, each of the ground plates 44 can have a respective material thickness that is defined by a fifth distance D5. In this regard, the ground plates 44 can be stamped from a sheet of metal in some examples, and formed as desired. However, the ground plates 44 can be alternatively fabricated as desired. The majority of the thickness of the ground plates 44 can be measured along the lateral direction A along a majority of the respective ground plate bodies 50. The fifth distance D5, can be measured from the inner ground plate surface 46 of the ground plate 44 to the outer ground plate surface 48 of the ground plate 44 along a direction normal to each of the inner ground plate surface 46 and the outer ground plate surface 48. The first distance D1 can be greater than the fifth distance D5. The second distance D2 can by greater than the fifth distance D5. The third distance D3 can be greater than the fifth distance D5. The fourth distance D4 can be greater than the fifth distance D5. In one example, the first distance D1 can be in a range from approximately two to approximately ten times greater than the fifth distance. It is recognized that the fifth distance D5 can be dimensioned as described above, or can define any suitable alternative distance as desired.

As described above, the distances D1-D5 can differ from those described above within the scope of the present disclosure. However, in accordance with one specific embodiment, the electrical connector 20 having the distances D1-D5 identified in accordance with the examples above is configured to operate at high date transfer speeds with reduced crosstalk when compared to conventional electrical connectors. Further, it should be appreciated that the connector 20 can include any number of pairs of adjacent leadframe assemblies that define respective air gaps 80. At least one such as a plurality of pairs of adjacent leadframe assemblies 36 can be defined by the first group 36a of leadframe assemblies, and at least one such as a plurality of pairs of adjacent leadframe assemblies 36 can be defined by the second group 36b of leadframe assemblies.

It should be appreciated that the illustrations and discussions of the embodiments shown in the figures are for exemplary purposes only, and should not be construed limiting the disclosure. One skilled in the art will appreciate that the present disclosure contemplates various embodiments. Additionally, it should be understood that the concepts described above with the above-described embodiments may be employed alone or in combination with any of the other embodiments described above. It should be further appreciated that the various alternative embodiments described above with respect to one illustrated embodiment can apply to all embodiments as described herein, unless otherwise indicated.

1. An electrical connector comprising:
an electrically insulative connector housing; and
a pair of leadframe assemblies including first and second adjacent leadframe assemblies supported by the connector housing, each of the leadframe assemblies comprising an electrically insulative leadframe housing, a plurality of signal contacts supported by the leadframe housing, and a ground plate secured to the leadframe housing,
wherein at least respective portions of the leadframe assemblies of the pair of leadframe assemblies are separated from each other along a lateral direction by an air gap.

2. The electrical connector of claim 1, wherein the air gap extends from the leadframe housing of the first leadframe assembly to the ground plate of the second leadframe assembly along the lateral direction.

3. The electrical connector of claim 1, further comprising a spacer rib that is disposed between the first and second adjacent leadframe assemblies of the pair of leadframe assemblies.

4. The electrical connector of claim 1, wherein the first and second adjacent leadframe assemblies belong to a first group of leadframe assemblies, and the electrical connector further comprises a second group of leadframe assemblies that are mirror images of the first group of leadframe assemblies.

5. (canceled)

6. The electrical connector of claim 1, wherein the air gap defines a first distance that extends from the ground plate of the first leadframe assembly to the electrically insulative leadframe housing of the second leadframe assembly.

7-10. (canceled)

11. The electrical connector of claim 6, further comprising a divider rib that separates the first group of leadframe assemblies from the second group of leadframe assemblies, wherein the plane extends through the divider rib.

12. The electrical connector of claim 11, wherein the divider rib defines a width along the lateral direction that is defined by a second distance, wherein the first distance is from approximately 20% to approximately 90% of the second distance.

13-20. (canceled)

21. The electrical connector of claim 11, further comprising a shield disposed in the divider rib.

22. The electrical connector of claim 21, wherein the shield is ungrounded.

23. The electrical connector of claim 22, wherein the shield comprises a magnetic absorbing material, an electrically lossy material or both.

24. The electrical connector of claim 21, wherein the shield has a width along the lateral direction defines a third distance.

25-27. (canceled)

28. The electrical connector of claim 24, wherein the first distance is in a range of approximately 10% to approximately 30% greater than the third distance.

29. (canceled)

30. The electrical connector of claim 6, wherein:
each leadframe housing defines an inner leadframe housing surface that faces the respective ground plate, and an outer leadframe housing surface opposite the inner surface along the lateral direction,
each ground plate defines an inner ground plate surface that faces the respective leadframe housing and an outer ground plate surface, and
each leadframe assembly defines a width from the outer leadframe housing surface to the outer ground plate surface along the lateral direction, and the width is defined by a fourth distance.

31. The electrical connector of claim 30, wherein the first distance is in a range from approximately 10% to approximately 60% greater than the fourth distance.

32-34. (canceled)

35. The electrical connector of claim 6, wherein each of the ground plates has a thickness that is defined by a fifth distance.

36. The electrical connector of claim 35, wherein first distance is greater than the fifth distance.

37-40. (canceled)

41. The electrical connector of claim 1, wherein the signal contacts of the first leadframe assembly is closer to the ground plate of the first leadframe assembly along the lateral direction than they are to the ground plate of the second leadframe assembly along the lateral direction.

42. The electrical connector of any one of claim 1, wherein the leadframe housing of each of the leadframe assemblies abuts the ground plate.

43. An electrical connector comprising:
a connector housing;
a first housing portion and a second housing portion that define an insulative leadframe housing, wherein the leadframe housing is carried by the connector housing; and
electrical contacts carried by the leadframe housing,
wherein the second housing portion defines at least one, at least two, at least three or three or more discrete, adjustable skew correction areas.

44. The electrical connector of claim 43 wherein a length of each respective adjustable skew correction area, as measured along a longitudinal direction, can be shortened or lengthened to increase or decrease skew in a differential signal pair of electrical contacts.

45. An electrical connector comprising:
a connector housing;
a first housing portion and a second housing portion that define an insulative leadframe housing, wherein the leadframe housing is carried by the connector housing; and
electrical contacts carried by the leadframe housing,
wherein the second housing portion defines at least one, at least two, at least three or at least four discrete, adjustable skew correction voids or respective air voids.

46. The electrical connector of claim 45 wherein the at least two or at least three of the discrete, adjustable skew correction voids or respective air voids each have equal or substantially equal or approximately equal exposed areas.

47. The electrical connector of claim 45, wherein the at least two, at least three, or at least four discrete, adjustable skew correction voids or respective air voids form identical or substantially identical or approximately identical perimeters or geometrical shapes.

48. The electrical connector of claim 45, wherein the electrical contacts comprise a plurality of right angle differential signal pairs and a respective air void closest in distance to a physically longest differential signal pair of the electrical contacts has an area of air or an exposed electrical contact area that is numerically smaller than another air void or exposed electrical contact area that is closest in distance to the physically shortest differential signal pair of electrical contact.

49. The electrical connector of claim 48 wherein the air voids, counting sequentially from the longest differential signal pair of electrical contacts to the shortest differential pair of electrical contacts, each maintain substantially numerically identical exposed areas or substantially identical exposed volumes of air or other material with a dielectric constant that is closer to air than plastic.

50. The electrical connector of claim 1, wherein each of the leadframe housings comprise a first housing portion and a second housing portion, and the second housing portion defines at least one, at least two, at least three or at least four discrete, adjustable skew correction voids or respective air voids.

51. The electrical connector of claim 50 wherein the at least two or at least three of the discrete, adjustable skew correction voids or respective air voids each have equal or substantially equal or approximately equal exposed areas.

52. The electrical connector of claim 50, wherein the at least two, at least three, or at least four discrete, adjustable skew correction voids or respective air voids form identical or substantially identical or approximately identical perimeters or geometrical shapes.

53. The electrical connector of claim 50, wherein the electrical contacts comprise a plurality of right angle differential signal pairs and a respective air void closest in distance to a physically longest differential signal pair of the electrical contacts has an area of air or an exposed electrical contact area bounded by an electrical non-conductive material that is numerically smaller than another air void or exposed electrical contact area that is closest in distance to the physically shortest differential signal pair of electrical contact.

54. The electrical connector of claim 53, wherein the air voids, counting sequentially from the longest differential signal pair of electrical contacts to the shortest differential pair of electrical contacts, each maintain substantially numerically identical exposed areas or substantially identical exposed volumes of air or other material with a dielectric constant that is closer to air than plastic.

55. The electrical connector of claim 50, wherein the signal contacts define differential signal pairs, and one electrical contact of a respective one of the differential signal pairs is exposed to air within the respective air void.

56. The electrical connector of claim 55, wherein each signal contact of the respective one of the differential signal pairs is exposed to air within the respective air void or have a respective skew compensation or corresponding air void \along respective lengths of the signal contacts.

57. The electrical connector of claim 50, wherein the air voids, counting sequentially from a longest differential signal pair of signal contacts to a shortest differential pair of signal contacts, maintains substantially numerically identical exposed areas or volumes of air or can increase in exposed areas or volumes of air.

58. The electrical connector of claim 57, wherein first and second air voids, counting sequentially from the longest differential signal pair to the shortest differential pair of signal contacts, have the same exposed areas of volume of air.

59. The electrical connector of claim 57, wherein counting sequentially from the longest differential signal pair to the shortest differential pair of signal contacts, a first air void is smaller in exposed area or volume than a second air void.

60. The electrical connector of claim 57, wherein counting sequentially from the longest differential signal pair to the shortest differential pair of signal contacts, a third air void has the same exposed area or volume as either or both of a first and a second air void.

61. The electrical connector of claim 57, wherein counting sequentially from the longest differential signal pair to the shortest differential pair of signal contacts, a fourth air void has the same exposed area or volume as one or more of first, second, and third air voids.

62. The electrical connector of claim 57, wherein counting sequentially from the longest differential signal pair to the shortest differential pair of signal contacts, a fourth air void has a larger exposed area or volume than one or more of first, second, and third air voids.

63. The electrical connector of claim 57, wherein counting sequentially from the longest differential signal pair to the shortest differential pair of signal contacts, first, second, and third air voids have approximately the same exposed areas or volumes.

64. A method of fabricating the electrical connector of claim 57, comprising adjusting skew by making an air void or corresponding exposed area to air of one or both signal contacts of a respective differential signal pair numerically larger or smaller.

65. A method of fabricating the electrical connector of claim 57, comprising adjusting skew by making at least one air void longer or shorter along a respective signal contact 22.
